(19) United States
(12) Patent Application Publication
(10) Pub. No.: US 2025/0272644 A1
(43) Pub. Date: Aug. 28, 2025

(54) SYSTEMS AND METHODS FOR AN OBJECT PROTECTION

(71) Applicant: Robert Paul Crozier, New York, NY (US)

(72) Inventor: Robert Paul Crozier, New York, NY (US)

(21) Appl. No.: 19/060,691

(22) Filed: Feb. 23, 2025

Related U.S. Application Data
(60) Provisional application No. 63/556,997, filed on Feb. 23, 2024.

(51) Int. Cl. G06Q 10/0832; B65B 55/20

(52) U.S. Cl. CPC G06Q 10/0832; B65B 55/20

(57) ABSTRACT

Systems and methods for protecting an object are disclosed. The object protection system for packaging a three-dimensional object comprises a scanner to scan the object and generate a digital representation of the object. The system comprises a feature database configured to store one or more attributes of the object identified from the digital representation. The one or more attributes comprises packaging contact points. The system further comprises an object analyzer configured to analyze the one or more attributes of the object to determine one or more brace inserts and material requirements for packaging. The system includes a fabrication subsystem configured to generate fabrication files based on the analyzed attributes and communicate with a manufacturing system to produce the one or more brace inserts. The system also includes a packing list generator configured to generate a customized packing list detailing assembly of the one or more brace inserts for packaging.

### CROSS-REFERENCE TO RELATED APPLICATION

This application claims the benefit of U.S. provisional patent Application No. 63/556,997 filed on Feb. 23, 2024, the contents of which are incorporated by reference herein.

### FIELD OF THE INVENTION

This invention relates to the field of object protecting systems and methods, particularly for safeguarding three-dimensional objects. The invention integrates three-dimensional scanning, attribute analysis, and fabrication processes to generate protective packaging solutions.

### BACKGROUND

Packaging and transportation of fine art and sculptural works present significant challenges due to the delicate and unique nature of these items. Traditionally, this work has been carried out by highly trained craftsmen who possess specialized knowledge about the handling of antiquities. Through years of training and experience, these craftsmen understand the structural vulnerabilities of sculptural pieces, such as how they may deform or flex during transit. They also know which packaging materials are compatible with the preservation of these objects and how to minimize the risk of damage during packing and unpacking. However, the reliance on skilled craftsmen presents several challenges. One major challenge is the limited availability of these experts. Packaging companies and other institutions often need to transport such technicians to their locations, which is both time-consuming and expensive. The scarcity of qualified craftsmen may lead to delays in packaging and transportation, increasing logistical complexity.

While some packaging systems exist for shipping generic or smaller items, they are inadequate for addressing the unique needs of sculptural works and three-dimensional objects. Existing systems often rely on standardized materials and methods that cannot account for the unique dimensions, fragile features, or irregular shapes of sculptural works. Standard packaging does not account for the specific stress points, contact areas, or delicate components of a three-dimensional object. Such oversights can lead to structural damage or surface abrasion during transportation. Current packaging solutions require manual measurements and designs, which are prone to human error and inefficiency. These processes lack precision, especially for complex geometries. Therefore, there is a need for an advanced solution for customized protection and packaging of three-dimensional objects, particularly sculpture artworks. There is a need in the art for ongoing research and development in this field.

### SUMMARY

The disclosed subject matter relates to an object protection system and a method for securely packaging three dimensional objects. The system comprises a scanner configured to scan a three-dimensional object and generate a digital representation of the object. The system further comprises a feature database configured to store one or more attributes of the object identified from the digital representation. The one or more attributes comprises packaging contact points associated with the object. The system further comprises an object analyzer configured to analyze the one or more attributes of the object. The object analyzer is further configured to determine one or more brace inserts and material requirements for packaging based on the analysis of the attributes. Further, the system includes a fabrication subsystem configured to generate fabrication files based on the analyzed attributes and communicate with a manufacturing system to produce the one or more brace inserts. The system further includes a packing list generator configured to generate a customized packing list detailing assembly of the one or more brace inserts for packaging.

In an exemplary embodiment, the scanner comprises one or more devices selected from image sensors, optical scanners, Radio Frequency (RF) scanners, X-ray scanners, and thermal scanners. The one or more attributes of the object comprise at least one of dimensions, weight distribution, surface fragility, points of stability, and areas unsuitable for packaging contact. The one or more attributes are identified by processing the digital representation of the object, the processing configured to analyze surface topology, material density, and structural balance of the object based on the digital representation. The object analyzer comprises an object database configured to store pre-determined data on material properties, such as impact resistance and vibration sensitivity, to determine the selection of brace insert types and materials. The object protection system further comprises a positioning platform configured to hold and rotate the object in multiple orientations during the scanning process for scanning coverage of all surfaces of the object. The customized packing list comprises step-by-step assembly instructions for the one or more brace inserts. Each instruction specifies a designated placement and orientation of the brace inserts relative to the identified packaging contact points. The fabrication subsystem is configured to generate fabrication files by processing the one or more attributes and the material requirements. The fabrication files comprise one or more instructions for the manufacturing system for producing customized brace inserts and other packaging supports. In some embodiments, the one or more brace inserts and the material used for packaging provide structural protection for the object during shipping and are customized based on the object's unique attributes.

Another general aspect is a method for protecting an object. The method includes scanning the object using a scanner to generate a digital representation of the object. The method further includes identifying one or more attributes of the object from the digital representation. The one or more attributes include packaging contact points. The method analyzes the one or more attributes to determine one or more brace inserts and material requirements for packaging. Further, the method includes generating one or more fabrication files based on the analyzed attributes and communicating the fabrication files to a manufacturing system to produce the one or more brace inserts. The method further includes generating a customized packing list detailing assembly of the one or more brace inserts for packaging the object. The scanner may comprise one or more devices selected from image sensors, optical scanners, RF scanners, X-ray scanners, and thermal scanners.

The method further includes storing the identified one or more attributes in a feature database. The one or more attributes of the object comprise at least one of dimensions, weight distribution, surface fragility, points of stability, and areas unsuitable for packaging contact. In some embodiments, identifying the one or more attributes comprises processing the digital representation to analyze surface topology, material density, and structural balance of the object. The object analyzer comprises an object database configured to store pre-determined data on material properties, such as impact resistance and vibration sensitivity, to determine the selection of brace insert types and materials. In some embodiments, scanning the object comprises positioning the object on a positioning platform and rotating the object in multiple orientations to capture all surfaces of the object. Further, the method includes generating one or more fabrication files by processing the one or more attributes and the material requirements. The one or more fabrication files comprises one or more instructions for the manufacturing system for producing customized brace inserts and other packaging supports. The customized packing list comprises step-by-step assembly instructions for the one or more brace inserts. Each instruction specifies a designated placement and orientation of the brace inserts relative to the identified packaging contact points. The one or more brace inserts and the material used for packaging provide structural protection to the object during shipping and are customized based on the object's unique attributes.

An exemplary embodiment is a computer-readable storage medium having data stored therein representing software executable by a computer, the software including instructions that, when executed, cause the computer-readable storage medium to perform generating a digital representation of an object scanned by a scanner. The instructions further cause the computer-readable storage medium to perform identifying one or more attributes of the object from digital representation. In some embodiments, the one or more attributes include packaging contact points. The instructions further cause the computer-readable storage medium to perform analyzing the one or more attributes to determine one or more brace inserts and material requirements for packaging. The instructions further cause the computer-readable storage medium to perform generating one or more fabrication files based on the analyzed attributes. The instructions further cause the computer-readable storage medium to perform communicating the fabrication files to a manufacturing system to produce the one or more brace inserts. The instructions further cause the computer-readable storage medium to perform generating a customized packing list detailing assembly of the one or more brace inserts for packaging the object.

This disclosed subject matter relates to protecting a three-dimensional object. The various embodiments and domains described herein should not be construed as limitations in the potential application of the disclosed subject matter. Rather they are teachings for the purpose of illustrating the ramifications and variations of possible embodiments of this disclosed subject matter. These and other embodiments are described in more detail in the following detailed descriptions and figures.

The foregoing is not intended to be an exhaustive list of embodiments and features of the disclosed subject matter. Persons skilled in the art are capable of appreciating other embodiments and features from the following detailed description in conjunction with the drawings.

### BRIEF DESCRIPTION OF THE DRAWINGS

FIG. 1 is a schematic illustrating a system for protecting an object in an embodiment of the disclosed subject matter.

FIG. 2 is a schematic illustrating an unpacking system in an embodiment of the disclosed subject matter.

FIG. 3 is a flow diagram of a process for protecting the object in an embodiment of the disclosed subject matter.

FIG. 4A is a schematic illustrating scanning of the object in an embodiment of the disclosed subject matter.

FIG. 4B is a schematic illustrating a digital representation of the object in an embodiment of the disclosed subject matter.

FIG. 4C is a schematic illustrating assembly of brace inserts to the object in an embodiment of the disclosed subject matter.

FIG. 4D is a schematic illustrating generation of the brace inserts using a manufacturing system in an embodiment of the disclosed subject matter.

FIG. 4E is a schematic illustrating the brace inserts created by the manufacturing system in an embodiment of the disclosed subject matter.

FIG. 4F is another schematic illustrating the brace inserts in three-dimensional form created by the manufacturing system in an embodiment of the disclosed subject matter.

FIG. 4G is a schematic example illustrating the assembly of brace inserts to a portion of the object in an embodiment of the disclosed subject matter.

FIG. 4H is another example illustrating the assembly of the brace inserts to the object in an embodiment of the disclosed subject matter.

FIG. 4I is a schematic illustrating a final view of the object protected with the brace inserts in an embodiment of the disclosed subject matter.

FIG. 4J is a schematic illustrating multiple views of the object protected with the brace inserts and protective components in an embodiment of the disclosed subject matter.

FIG. 4K is a schematic illustrating the object and its corresponding packaging mold in an embodiment of the disclosed subject matter.

FIG. 4L is a schematic illustration of a packaging box in an embodiment of the disclosed subject matter.

FIG. 5A depicts another illustration of a process or method for protecting an object in an embodiment of the disclosed subject matter.

FIG. 5B illustrates a process for scanning and documenting objects in an embodiment of the disclosed subject matter.

FIG. 5C illustrates a fabrication process in an embodiment of the disclosed subject matter.

FIG. 6A to 6D depicts another illustration of a method for protecting an object in an embodiment of the disclosed subject matter.

FIG. 7 is a schematic of a generic computer system that can implement various components and functionalities described in the disclosed subject matter.

### DETAILED DESCRIPTION

The disclosed subject matter relates to a system and a method for protecting an object. In an embodiment, the system and the method are specifically designed for packaging and shipping three-dimensional objects. The system is an integration of scanning technology, attribute analysis, customized packaging components fabrication, and packing instructions generation. The system provides a customized approach for safeguarding objects, especially those that are fragile, irregularly shaped, or of high value.

The system comprises a scanner capable of capturing a three-dimensional object and generating a digital representation of the object. The scanner may incorporate various technologies, including image sensors, optical scanners, RF scanners, X-ray scanners, or thermal scanners. The scanner is selected based on material and structural characteristics of the object for generating a highly accurate and comprehensive digital model or representation. In an embodiment, the object is placed on a positional platform and rotated in multiple orientations during the scanning process to capture full coverage of the object. This enables the capturing of all surfaces, contours, and critical features of the object without omission. The system identifies one or more attributes of the object from the digital representation. For example, the one or more attributes include factors such as dimensions, weight distribution, surface fragility, points of stability, and areas unsuitable for direct packaging contact. Further, the system processes and analyzes the digital representation to evaluate the object's surface topology, material density, structural balance, and other attributes. These attributes are stored in a feature database, providing a reference for subsequent packaging design and material selection.

The system further comprises an object analyzer for processing the identified attributes. The object analyzer analyzes the identified attributes to determine one or more brace inserts and material requirements for packaging the object. The object analyzer accesses an object database comprising a pre-determined data on material properties, such as impact resistance and vibration sensitivity. In an embodiment, the object database may also include object categories, physical properties, structural attributes, material properties, packaging information, digital representations of various three-dimensional objects, packaging performance records, industry specific data, and related data. Based on the analysis of identified attributes and the pre-determined data, the object analyzer determines the one or more brace inserts, and the material required for protecting the object. For example, the one or more brace inserts are custom-designed structural components that provide protection for an object during packaging, handling, and shipping. These brace inserts ensure that the object remains stable, secure, and undamaged, especially when dealing with delicate, irregularly shaped, or high-value objects such as artwork, or fragile products.

In embodiments, the system generates one or more fabrication files using a fabrication subsystem. Using the analyzed attributes and material requirements, the fabrication subsystem generates detailed fabrication files. In some examples, the fabrication files may contain precise instructions for manufacturing the brace inserts and other necessary packaging supports. The fabrication files are communicated to a manufacturing system, such as a 3D printer or a Computer Numerical Control (CNC) machine. The CNC machine is a computer-controlled manufacturing device used to produce precise and customized components designed to align perfectly with the object's unique features and packaging contact points.

In embodiments, the system includes a packing list generator that creates a customized packing list. This packing list provides step-by-step assembly instructions, specifying the placement and orientation of each brace insert relative to the object's contact points. These instructions ensure a precise and secure assembly, making the process efficient and accessible even for non-specialist users. The brace inserts and packaging materials disclosed in this subject matter are designed to offer structural protection customized to the object's attributes. By providing shock absorption, vibration resistance, and protection against environmental factors, the system enables the object to remain intact during transportation. This customization reduces the risk of damage, enhances shipping reliability, and minimizes waste by optimizing material usage.

The disclosed subject provides a solution for protecting three-dimensional objects for packaging and shipping. This makes the disclosed subject matter particularly suitable for high-value or delicate items that require exceptional care. The detailed packing list further enhances usability, allowing for easy and accurate assembly. The flexibility of the system makes it ideal for a wide range of applications. The system can be used to ship fine art, such as paintings or sculptures, so that these irreplaceable items arrive in pristine condition. It is equally effective for transporting sensitive medical devices, laboratory equipment, or high-value consumer goods like electronics and luxury items. In some embodiments, the system could incorporate additional features, such as real-time condition monitoring with sensors embedded within the packaging to track environmental factors like temperature, humidity, and shock, and provide real-time feedback to a sender and a receiver.

In embodiments, the disclosed object protection system is beneficial for packaging medical devices, such as prosthetics, which are uniquely designed for individuals. The prosthetic devices are required to be transported with extreme care to prevent damage or misalignment. Given the unique structures and fragility, a customized packaging approach ensures that each prosthetic device is securely held with the brace insert. The system scans, analyzes, and generates packaging solutions customized to each medical device. By incorporating attributes such as weight distribution, points of stability, and surface fragility, the system ensures that prosthetic devices arrive in pristine condition.

Further, the customized packaging generated by the system not only protects the integrity of the prosthetics but also meets industry standards for sterility and safety. The detailed packing list facilitates proper assembly and ensures that the packaging remains consistent across multiple shipments.

In embodiments, the object protection system is beneficial for military deployments that require customized packaging solutions to protect sensitive armaments and equipment. The armaments may be specifically configured for deployment in unique environments, necessitating customized packaging that meets military standards. The disclosed system offers an efficient solution by analyzing the individual specifications of military equipment and generating customized packaging. The customized packaging ensures compliance with durability, impact resistance, and environmental protection standards. The system's object scanning and brace insert generation capabilities enable military shipments to be securely packaged to prevent individual components from contacting.

Military operations often require rapid deployment across diverse transportation methods, including air, land, and sea. The object protection system creates packaging solutions optimized for each mode of transport so that armaments remain intact and fully functional upon arrival. Further, the customized packing list streamlines the assembly process, allowing efficient unpacking and deploying equipment in the field with minimal delays.

In embodiments, the object protection system is beneficial for space applications. In the field of space exploration, packaging solutions must address the challenge of minimizing weight while ensuring structural integrity. The disclosed system provides a means to design lightweight yet robust packaging for equipment to endure the extreme forces of liftoff. The system analyzes the object's attributes, such as material density, structural balance, and impact resistance, and creates efficient packaging that meets the rigorous demands of space travel. By using minimal and strategically placed brace inserts, the system secures delicate instruments and components while reducing overall payload weight.

In embodiments, the disclosed object protection system enhances the efficiency of import and export processes. The disclosed system generates packaging that allows customs agents to easily view and verify products without compromising security. By designing packaging with designated inspection windows or removable brace inserts, the system ensures that customs personnel can match the contents to the shipping manifest, reducing delays at border checkpoints.

In some cases, international shipping often involves exposure to varying environmental conditions, such as humidity, temperature fluctuations, and rough handling. The system analyzes material properties and selects appropriate packaging materials so that goods remain protected throughout transit. Whether dealing with fragile electronics, pharmaceuticals, or industrial equipment, the system provides a customized solution that meets regulatory standards and facilitates efficient customs processing.

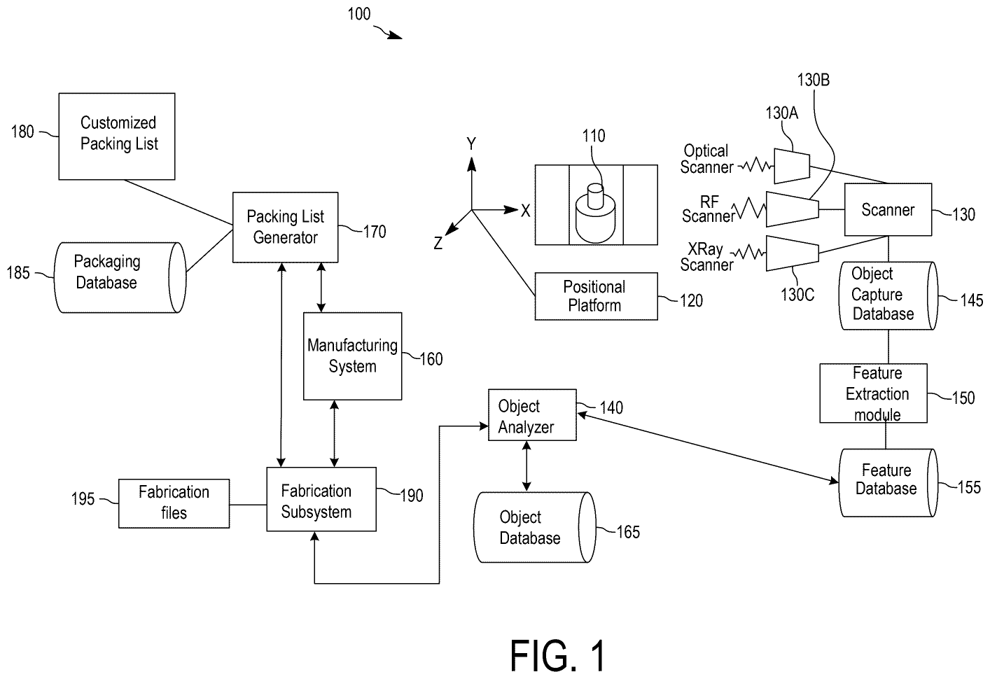

Representative embodiments according to the disclosed subject matter are shown in FIGS. 1 to 6. The specific embodiments are meant to be illustrative and not limited to the scope of the disclosed subject matter and the various ways it may be embodied.

Referring to FIG. 1, FIG. 1 is a schematic illustrating a system 100 for protecting an object. The system 100 comprises a scanner 130, a positional platform 120 to hold the object 110, a feature extraction module 150, an object analyzer 140, a fabrication subsystem 190, a manufacturing system 160, a packing list generator 170, an object capture database 145, a feature database 155, and a packaging database 185. The system 100 demonstrates the interaction between these components, emphasizing the system's 100 overall functionality.

The object 110 may be any physical item that is to be protected for packaging and shipping. For example, the object 110 may be a three-dimensional object that requires secure packaging for shipping to a different location. Each object may be unique, possessing its own set of characteristics such as dimensions, weight distribution, fragility, and material composition. These three-dimensional objects can vary widely in size, shape, material composition, and fragility, making it essential to design custom packaging for each object.

The scanner 130 is a device configured to capture an object 110 to be protected and create a digital representation of the object 110. The scanner 130 may be as an entry point for the entire object protection process. The scanner 130 is capable of creating a three-dimensional (3D) digital model or digital representation of the object 110 by integrating various sensors and scanning technologies. In embodiments, the scanner 130 integrates technologies such as optical scanners 130A, RF scanners 130B, X-ray scanners 130C, image sensors, LiDAR scanners, thermal scanners, and other sensors capable of capturing various attributes of the object 110.

The image sensors may capture high-resolution two dimensional and three-dimensional images that assist in mapping the external surface of the object 110. The optical scanners 130A may use lasers or structured light to measure surface geometry accurately. The RF scanners 130B may employ radio frequencies to detect internal components or voids. For instance, they are useful for scanning objects wrapped in opaque covering. The X-ray scanners 130C provide insights into internal structures especially for delicate or complex items, such as electronic devices or antiques. The LiDAR (Light detection and Ranging) scanners include a remote sensing technology that uses laser beams to capture three dimensional objects. The LiDAR scanner is positioned near the object 110, either as a stationary device or as a portable handheld scanner. The LiDAR scanner aligns the laser beams with the object surface to provide accurate measurements to create the digital representation of the object. The thermal scanners are capable of capturing heat distribution data, which is relevant for temperature-sensitive materials such as certain medical supplies or adhesives. Thus, the various sensors and scanning technologies enable the system to capture the object's precise geometry, surface features, and even internal structural characteristics. For instance, the scanned data captured by various scanners is stored in the object capture database 145.

The scanner 130 used for capturing the object 110 may vary depending on the size, complexity, and type of the object 110. In embodiments, the scanner 130 may include handheld scanners that allow operators to move around the object 110 and capture intricate details from multiple angles. Goggles or glasses-based scanners incorporating augmented reality (AR) or virtual reality (VR) technologies may be used to visualize the scanning process in real time and ensure accuracy while capturing the object 110. Phone-based scanners with advanced camera technologies and LiDAR sensors integrated into modern smartphones may be used to provide a compact and accessible solution for smaller objects or quick scans. Tripod-mounted scanners may be used to deliver stability and precision, particularly for larger or stationary objects.

The scanner 130 is further configured to generate the digital representation of the object 110 using the scanned data. For instance, the digital representation may be a three-dimensional model that depicts the geometry, dimensions, and sometimes the texture or material properties of the object 110. For example, the digital representation is generated through computational processes and consists of mathematical data structures like point clouds, polygonal meshes, or parametric surfaces. In some embodiments, the scanner 130 collects millions of data points that describe the object's surface in three-dimensional space. Each point may have X, Y, and Z coordinates. The scanner 130 may use specialized software that processes the scanned data to generate a structured digital representation of the object 110 made of vertices, edges, and faces.

The positional platform 120 is configured to hold the object 110 during the scanning process. The positional platform 120 is equipped with rotational mechanisms that allow the object 110 to be oriented in multiple positions. For example, the object 110 can be rotated to expose its base, sides, and top for a comprehensive scan. In some embodiments, the positional platform 120 enables 360-degree rotation for complete scanning coverage. This is especially critical for objects with hidden recesses or uneven shapes, such as a model airplane with intricate undercarriage details. Further, the positional platform 120 may have precise alignment and positioning capabilities to ensure that all surfaces of the object 110 are scanned with minimal distortion or blind spots. In some embodiments, scanning larger objects may require the scanner 130 to move around the object 110 to capture complete geometry of the object 110. In some embodiments where the scanner 130 is held by a user manually to scan the object 110, the user may move around the object 110 to capture the scan of the object 110. For instance, portable scanning devices, such as handheld 3D scanners, LiDAR systems, and mobile scanning systems are used to traverse around the object 110, capturing data from multiple angles.

The object capture database 145 is configured to store the scanned data and the digital representations of three-dimensional objects captured during the initial scanning process. After the scanner 130 processes the scanned data, the generated digital representations are stored in the object capture database 145. For instance, the digital representations are stored in file formats compatible with the fabrication subsystem 190 and other components of the object protection system 100. The object capture database 145 further stores a metadata associated with the digital representation and the object's metadata. For example, the metadata of the digital representation comprises file size, resolution, and scanning parameters. The object's metadata may comprise object ID, name, and description of the object 110.

The feature extraction module 150 is configured to process the scanned data and the digital representation to identify one or more attributes associated with the object 110. In embodiments, the feature extraction module 150 processes the digital representation of the object 110 to analyze surface topology, material density, structural balance, and other features of the object 110. Based on the analysis, the feature extraction module 150 is configured to identify the one or more attributes of the object 110. For instance, the one or more attributes comprise dimensions, weight distribution, surface fragility, points of stability, packaging contact points, areas unsuitable for packaging contact, and related attributes. For example, while analyzing a glass ornament, the feature extraction module 150 may highlight the thinner, more fragile edges that require additional cushioning. In some embodiments, the scanned data undergoes processing to identify attributes such as edges, contours, and textures.

The feature extraction module 150 is further configured to analyze the geometry of the object and determine unique attributes such as curves, corners, and flat areas. Using this analysis, the feature extraction module 150 maps one or more points on the digital representation that represents packaging contact points, sharp edges, and similar attributes of the object 110.

The feature database 155 of the system 100 is configured to store the one or more attributes of the object 110 identified by the feature extraction module 150. In embodiments, the feature database 155 is a specialized data repository designed to store, organize, and manage the one or more attributes of the scanned three-dimensional objects. The feature database 155 acts as a central hub of information and enables seamless interaction between various components of the system 100. The feature database 155 confirms that all essential details about the object's features are readily accessible for analysis, packaging customization, and manufacturing processes.

In embodiments, the feature database 155 is designed to store the one or more attributes extracted from the digital representation of the object 110. For instance, the feature database 155 may include physical dimensions (height, width, depth), the object's weight distribution, center of gravity, surface fragility, areas prone to damage, stability points, unsuitable zones for contact, and similar attributes associated with the object 110. For example, for a fragile glass vase, the feature database 155 may store the attributes as maximum height: 25 cm, weight center: 10 cm from base, and fragility zones: upper rim and handles.

In some embodiments, the attributes in the feature database 155 are indexed and categorized for efficient retrieval. Example categories include material type, packaging needs, and sensitivity level for a rapid access for further analysis or fabrication processes. The feature database 155 supports scalability to manage diverse objects, from small fragile items like jewelry to larger complex objects like sculptures or machinery parts. In embodiments, the feature database 155 can handle bulk data for an art shipping company with hundreds of different objects. For instance, the feature database 155 supplies stored attributes to the object analyzer 140 for determining packaging requirements and brace insert designs.

The object analyzer 140 is configured to analyze the one or more attributes of the object 110 to determine one or more brace inserts and material requirements for packaging. The object analyzer 140 is a crucial component of the object protection system 100, designed to process the attributes of the scanned object 110 and determine the optimal brace inserts and materials required for secure packaging. In embodiments, the object analyzer 140 is a combination of advanced algorithms, pre-stored material data, and real-time attribute analysis to confirm that each object receives customized packaging solutions.

For instance, the object analyzer 140 comprises the object database 165, which contains a comprehensive repository of pre-determined data about material properties and packaging guidelines. The object database 165 provides an input for the object analyzer 140 for selecting brace insert types and materials. In an embodiment, the object database 165 comprises the pre-determined data about object categories, physical properties, structural attributes, material properties, packaging information, digital representations of various three-dimensional objects, packaging performance records, industry specific data, and related data.

The object database 165 may also include data related to impact resistance that specifies how much energy a material can absorb without failing. Further, the object database 165 includes vibration sensitivity indicating the material's tolerance to sustained vibrations during transport. The object database 165 also includes data related to thermal and environmental tolerance that defines the resistance of materials to temperature changes or moisture exposure. The object database 165 further includes data related to elasticity and rigidity that helps in determining whether the material can provide adequate support without damaging the object 110.

In embodiments, the object analyzer 140 evaluates the identified attributes stored in the feature database 155 alongside the predetermined data stored in the object database 165 to define a packaging solution. For instance, the object analyzer 140 designs the one or more brace inserts that fit snugly around the object 110 by analyzing the attributes and the three-dimensional surface topology of the object 110. The object 110 with irregular shapes, such as sculptures, benefit from inserts molded precisely to their contours. Based on analysis of the identified attributes and the predetermined data on material properties, the object analyzer 140 determines the types of brace inserts, placement points, insert shapes and sizes.

For example, the brace inserts are custom-designed protective components used in packaging systems to secure and stabilize objects during storage, transportation, or handling. They act as cushioning or structural support elements to prevent physical damage, such as scratches, dents, or breakage, by distributing forces and isolating the object 110 from external impacts, vibrations, or shifts. The object analyzer 140 categorizes the brace inserts as cushioning (e.g., foam), stabilizing (e.g., rigid plastic), or structural (e.g., reinforced frames). The placement points are the packaging contact points that provide support at stability zones while avoiding fragile areas. The insert shapes and sizes are custom molds or cutouts designed to hold the object 110 securely, with minimal movement. In some embodiments, the center of gravity and weight distribution data guide the design of the brace inserts to prevent tipping or shifting during transport. For instance, a top-heavy object would require additional braces near its base.

Upon determining the brace inserts, the object analyzer 140 determines the material requirements for packaging and protecting the object 110. For instance, the material requirements may include a primary packaging requirements and a secondary packaging requirements. The primary packaging requirements may comprise materials for brace inserts, such as foam, plastic, or corrugated cardboard. The secondary packaging requirements comprise outer box specifications, including dimensions, strength, and padding requirements. In some embodiments, the material requirements also include shipping adaptations, adjustments for thermal insulation, water resistance, or stacking compatibility. For high-value items, such as artwork, the object analyzer 140 may recommend materials with UV protection or anti-static properties to preserve the object's condition during long-term storage or transit. In some examples, fragile objects, such as ceramic vases, are matched with soft, non-abrasive materials to avoid scratches or cracks. Meanwhile, durable objects may utilize harder materials for cost-effective protection.

The fabrication subsystem 190 is configured to generate one or more fabrication files 195 by processing the one or more attributes and the material requirements. For instance, the fabrication subsystem 190 creates digital instructions, or fabrication files, necessary for producing custom protective components. Using the data determined by the object analyzer 140 and analyzing the identified attributes, the fabrication subsystem 190 generates detailed fabrication files 195 specifying the dimensions, material properties, and shapes of brace inserts. The fabrication files 195 comprise one or more instructions for the manufacturing system 160 for producing customized brace inserts and other packaging supports.

The fabrication files 195 are sent to the manufacturing system 160 for production, for a smooth transition from digital design to physical implementation. In some embodiments, the fabrication subsystem 190 is responsible for translating the analyzed object attributes and packaging requirements into actionable instructions for manufacturing the custom brace inserts and other packaging components. It bridges the gap between digital design and physical production for precision, efficiency, and customization in the object protection process. For example, these files may include CAD (Computer-Aided Design) files for defining the three-dimensional geometry of the brace inserts, CNC (Computer Numerical Control) instructions for precise cutting and shaping of materials, 3D printing files in formats like STL or OBJ for additive manufacturing processes. In some embodiments, the fabrication subsystem 190 may operate in a cloud environment, allowing seamless integration with other system components like the object analyzer 140 and the feature database 155. This provides real-time data sharing and updates, reducing delays and errors in the production process.

The manufacturing system 160 is a crucial component in the object protection system, translating digital fabrication files 195 into physical protective packaging elements, such as brace inserts. The manufacturing system 160 provides the precise and efficient production of custom packaging components designed to the unique attributes of the object 110 being protected. The integration of advanced machinery, automation, and material handling processes ensures that the manufacturing system 160 operates with high accuracy, speed, and quality.

For instance, the manufacturing system 160 comprises CNC machines, 3D printers, laser cutters, robotic systems, and other machinery required to produce the packaging components. In one example, the CNC machines are used to precisely cut or shape materials based on the digital representation and design specifications. In another example, the 3D printers are used to manufacture complex brace inserts layer by layer, ideal for objects with intricate packaging needs. In yet another example, the laser cutters are used to accurately cut or engrave packaging materials for customized fits. The robotic systems may be used to automate repetitive tasks such as assembly, labeling, and quality checks.

The manufacturing system 160 thus produces the one or more brace inserts and the materials required for packaging the object using the fabrication files 195. In some embodiments, one or more sensors embedded in the manufacturing system 160 monitor production metrics such as dimensions, material usage, and surface finish. The manufacturing system 160 may also generate alerts in case of deviations for high-quality outputs. Further, the brace inserts and the packaging components or packaging supports undergo stress tests to validate their durability and protective capabilities. For instance, the brace insert for a glass object might be tested for impact resistance under simulated shipping conditions.

The packing list generator 170 is configured to generate a customized packing list 180 detailing assembly of the one or more brace inserts for packaging the object 110. The packing list generator 170 is designed for precision and clarity in the assembly of customized packaging solutions. It bridges the gap between the digital analysis of the object's attributes and the physical implementation of packaging materials. For example, the customized packing list 180 includes detailed step-by-step instructions for assembling the brace inserts and other packaging elements to securely protect the object 110 during storage or transit.

In embodiments, the packing list generator 170 processes data derived from the object analyzer 140 and the fabrication subsystem 190 to create the customized packing list 180. For instance, the customized packing list 180 specifies the exact placement of the brace inserts, the orientation of the inserts relative to the object's packaging contact points, instructions for layering, stacking, or securing materials to provide maximum stability and protection, and other assembly instructions. In some embodiments, the customized packing list 180 comprises instruction steps for assembly, where each step is broken down systematically to facilitate seamless execution by operators or automated packing systems. For example, the instruction steps may include Step 1: Place the base foam brace with cavity A facing upward, Step 2: Align the object's bottom contact points with the marked slots on the base brace, and Step 3: Insert lateral braces to secure side surfaces, so that no direct contact with fragile areas.

In some embodiments, the packing list generator 170 adapts to modifications in the object's attributes or packaging requirements by updating the instructions in real-time. This flexibility ensures that the customized packing list 180 remains relevant even in changing scenarios, such as varying shipping conditions. In other embodiments, the packing list generator 170 generates interactive visual guides and the customized packing list 180 often incorporates visual aids, such as 3D models to demonstrate the correct placement and alignment of packaging elements. The customized packing list 180 may also include diagrams and videos for highlighting orientation and contact points on the object 110 and providing animated assembly steps for complex packaging tasks.

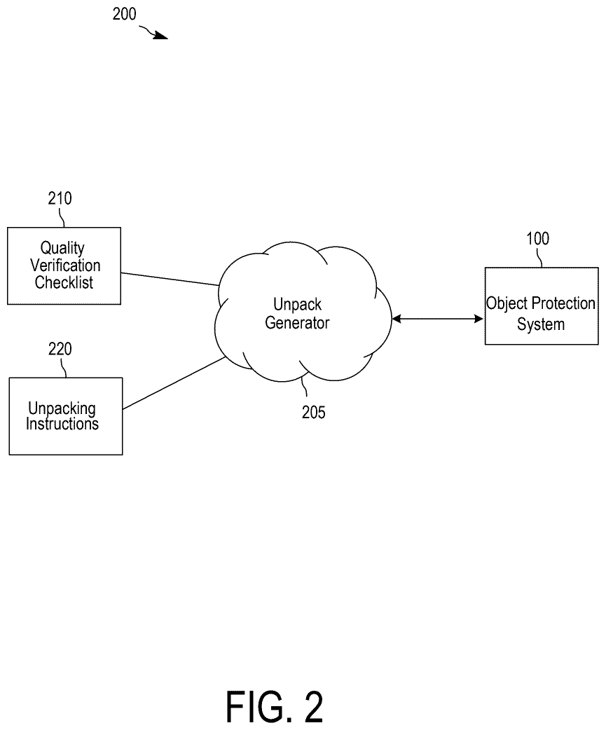

Referring to FIG. 2, FIG. 2 is a schematic illustrating an unpacking system 200 in an embodiment of the disclosed subject matter. The unpacking system 200 comprises an unpack generator 205 communicatively coupled to the object protection system 100.

The unpack generator 205 is designed for the object protection and unpacking of packaged objects and quality verification upon receipt. In embodiments, the unpack generator 205 integrates data analysis, interactive instructions, and validation mechanisms to enhance user experience and maintain the integrity of the packaging process. For instance, the unpack generator 205 utilizes the digital representation of the object 110 and its corresponding customized packing list 180 generated during the packaging phase to determine step-by-step unpacking instructions. The unpacking instructions 220 are personalized to the specific configuration of the brace inserts, packaging materials, and the object's contact points. For example, the unpacking instructions 220 may include visual aids such as annotated diagrams, augmented reality (AR) overlays, or QR-code-embedded videos. The unpacking instructions 220 also include sequential steps detailing the disassembly of the brace inserts and handling of fragile or critical sections. The unpacking instructions 220 may also include warnings for areas unsuitable for direct contact during unpacking.

The unpack generator 205 is further configured to generate a quality verification checklist 210 to assess the quality of the object 110. For instance, the unpack generator 205 generates the quality verification checklist 210 alongside unpacking instructions 220 to assess the condition of the object post-transit. For example, the quality verification checklist 210 includes criteria such as visual inspection of the object 110 for damages, assessment of the structural integrity of the brace inserts, and cross-verification of the received object.

In some embodiments, the unpack generator 205 interfaces with user devices such as smartphones or tablets to enable real-time feedback and reporting of the packaging quality. For example, users may upload photos or videos of the unpacked object for automated analysis or manual review. The unpack generator 205 may further mark discrepancies, such as missing brace inserts or damaged packaging, which are logged into the object protection system 100 for corrective actions. In embodiments, advanced image recognition algorithms may compare pre-shipping scans of the object 110 with post-unpacking photos to flag deviations, anomalies, or potential damage.

The unpack generator 205 is configured to record user feedback and quality assessments to refine future packaging designs. For example, repeated damage patterns or user difficulties during unpacking may prompt modifications to brace insert designs or adjustments in the packing list. In embodiments, the unpack generator 205 transforms the post-delivery experience by bridging the gap between packaging integrity and user interaction.

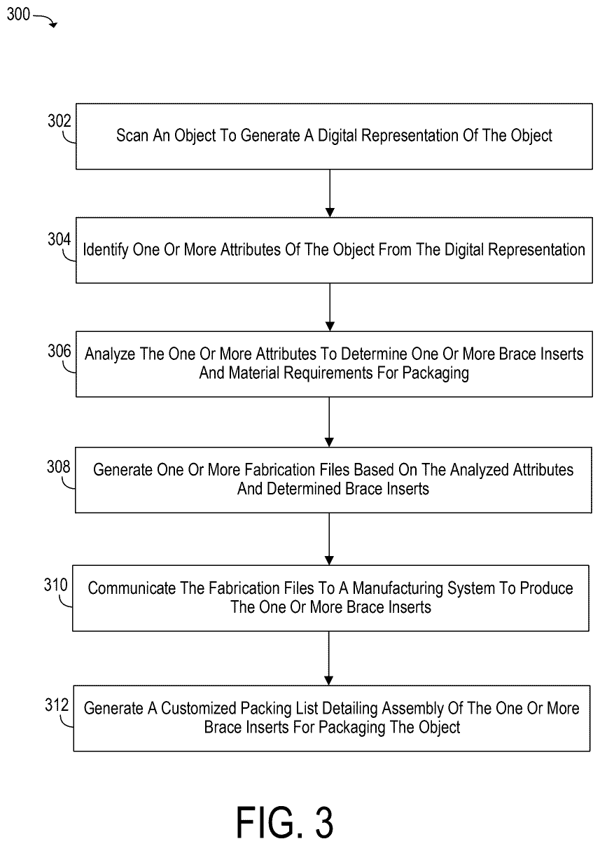

Referring to FIG. 3, FIG. 3 is a flow diagram of a process 300 for protecting an object in an embodiment of the disclosed subject matter. The process of the flow diagram 300 may be implemented to protect a three-dimensional object for packaging and shipping securely.

At step 302 of the flow diagram, the process 300 scans an object to generate a digital representation of the object. For instance, the process generates the digital representation of the object using the scanned data. The scanner can incorporate technologies such as image sensors, optical scanners, RF scanners, X-ray scanners, or thermal scanners, chosen based on the material and structural properties of the object. To provide comprehensive coverage, the object is placed on a positional platform that rotates the object in multiple orientations, allowing the scanner to capture all surfaces, contours, and critical features. This rotation eliminates blind spots for creating a high-resolution and accurate digital model of the object.

The process further generates the digital representation of the object using the scanned data. For instance, the scanner collects millions of data points that describe the object's surface in three-dimensional space, each point has X, Y, and Z coordinates. For example, the digital representation is generated through computational processes and consists of mathematical data structures like point clouds, polygonal meshes, or parametric surfaces. The process analyzes the point cloud to generate the digital representation of the object comprising vertices, edges, and faces.

At step 304 of the flow diagram, the process 300 identifies one or more attributes of the object from the digital representation. For instance, the generated digital representation is processed to extract the one or more attributes of the object. These attributes include dimensions, weight distribution, surface fragility, points of stability, areas unsuitable for packaging contact, and related features associated with the object. For example, dimensions may include length, width, height, and volumetric details of the object. The weight distribution may comprise identifying areas prone to imbalance. The surface fragility includes detecting delicate or breakable regions. The point of stability includes determining areas that provide structural support.

In embodiments, the process analyzes surface topology, material density, structural balance, and other features of the object using the digital representation. The process further maps one or more points on the digital representation that represents packaging contact points, sharp edges, and similar attributes of the object. The identified attributes are stored in a feature database, forming a reference for subsequent steps.

At step 306 of the flow diagram, the process 300 analyzes the one or more attributes to determine one or more brace inserts and material requirements for packaging. For instance, the process analyzes the attributes stored in the feature database and an object database that includes pre-determined data. The predetermined data may include material properties (for example, impact resistance, vibration sensitivity), various object categories and structural attributes, packaging performance records and industry-specific standards. By analyzing the attributes and the predetermined data, the process determines the one or more brace inserts, and the material required for packaging the object. These brace inserts are designed to stabilize the object, prevent damage during handling or shipping, and accommodate the unique shape and fragility of the object. The brace inserts are molded to match the exact contours of irregularly shaped objects, providing a snug and stable fit.

In embodiments, the process further categorizes the brace inserts based on their design and material. For instance, the brace inserts may be categorized into cushioning inserts, stabilizing inserts, and structural inserts. The cushioning inserts may be made from materials like foam to absorb shocks. The stabilizing inserts may be composed of rigid plastics to keep the object in place. The structural inserts may include reinforced frames to provide additional strength. In embodiments, the shape, size, and placement of the brace inserts are optimized to provide maximum support while avoiding fragile or unstable areas.

Upon designing the brace inserts, the process determines material specifications for both primary and secondary packaging. In one example, the primary packaging includes materials for the brace inserts, such as foam for delicate objects, hard plastic for more durable items, and corrugated cardboard for lightweight but sturdy protection. In another example, the secondary packaging encompasses outer packaging specifications such as box dimensions and strength, padding for additional protection, and specialized features, such as thermal insulation or water resistance, for specific conditions. In some embodiments, for high-value or sensitive items, the process recommends advanced materials may be recommended such as ultraviolet protection to prevent damage from light exposure, and anti-static properties for electronics or items sensitive to static electricity.

At step 308 of the flow diagram, the process 300 generates one or more fabrication files based on the analyzed attributes and the determined brace inserts. For instance, the one or more brace inserts and the material determined in the step 306, and the identified attributes of the object are processed to create the one or more fabrication files. The fabrication files may comprise one or more instructions for a manufacturing system for producing customized brace inserts and other packaging supports. In embodiments, the fabrication files are created in a format compatible with the manufacturing system.

At step 310 of the flow diagram, the process 300 communicates the one or more fabrication files to the manufacturing system to produce the one or more brace inserts. For instance, the manufacturing system comprises CNC machines, 3D printers, laser cutters, robotic systems, and other machinery required to produce the packaging components. The manufacturing system, guided by the fabrication files, produces the customized brace inserts for protecting the object. These inserts are designed for shock absorption, vibration resistance, and protection against environmental factors. In some embodiments, the manufacturing system selects the materials of the brace inserts based on the object's needs, optimizing both protection and material efficiency. For example, delicate objects may use foam-based inserts, while heavier items may use rigid materials.

At step 312 of the flow diagram, the process 300 generates a customized packing list detailing assembly of the one or more brace inserts for packaging the object. For instance, the customized packing list is a detailed, step-by-step guide for assembling the packaging. The packing list specifies placement and orientation of each brace insert, and assembly instructions for securing the object. This step makes the assembly process user-friendly and efficient, even for non-specialists. The packing list ensures that the object is securely enclosed and protected during shipping.

In some embodiments, the packing list adapts to modifications in the object's attributes or packaging requirements by updating the instructions in real-time. In other embodiments, the packing list includes interactive visual guides and incorporates visual aids, such as 3D models to demonstrate the correct placement and alignment of packaging elements. The packing list may also include diagrams and videos for highlighting orientation and contact points on the object and provide animated assembly steps for complex packaging tasks.

The process 300 thus confirms that the object is scanned, analyzed, and packaged with a high degree of customization and precision, safeguarding it during transportation while optimizing material usage and reducing waste. The process 300 is ideal for fragile, irregularly shaped, or high-value items such as artwork, medical devices, and luxury objects.

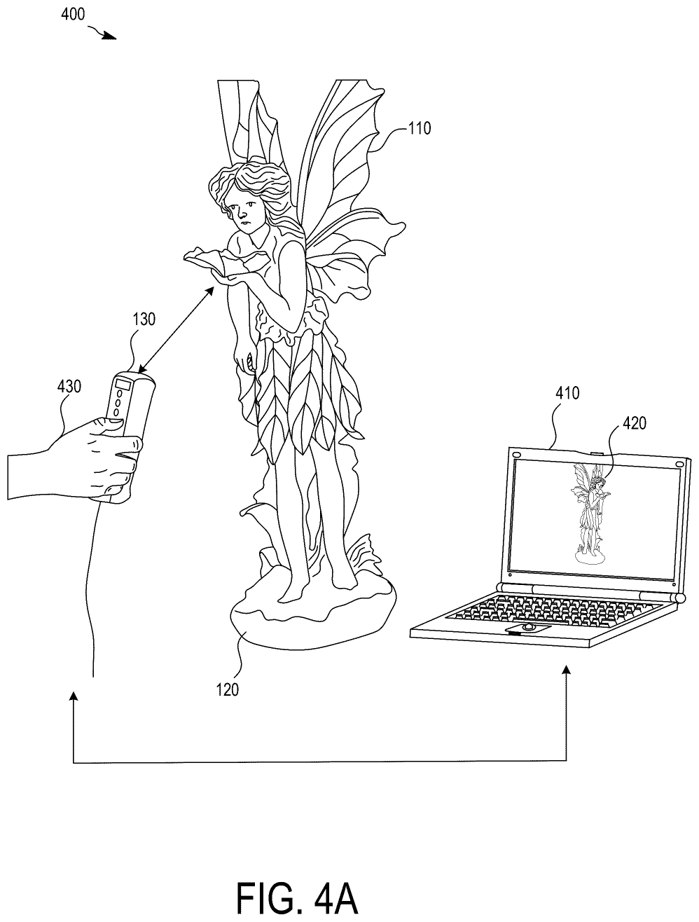

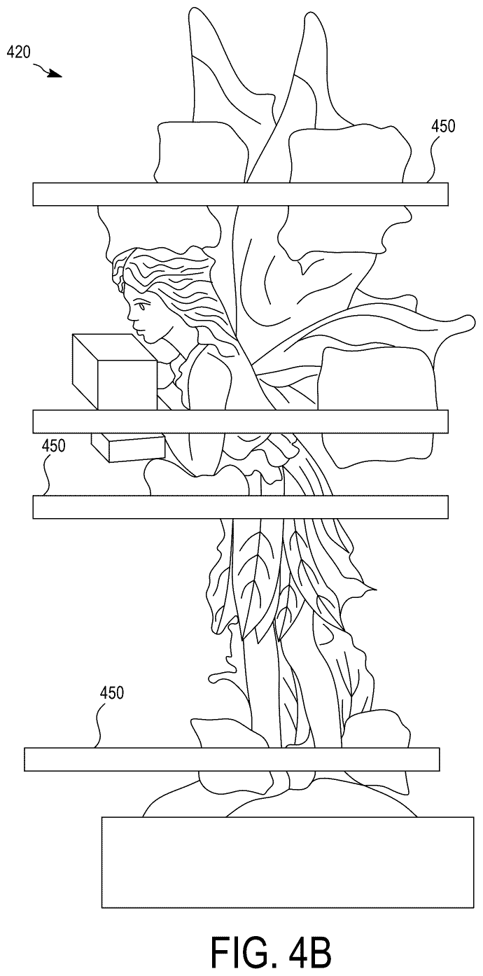

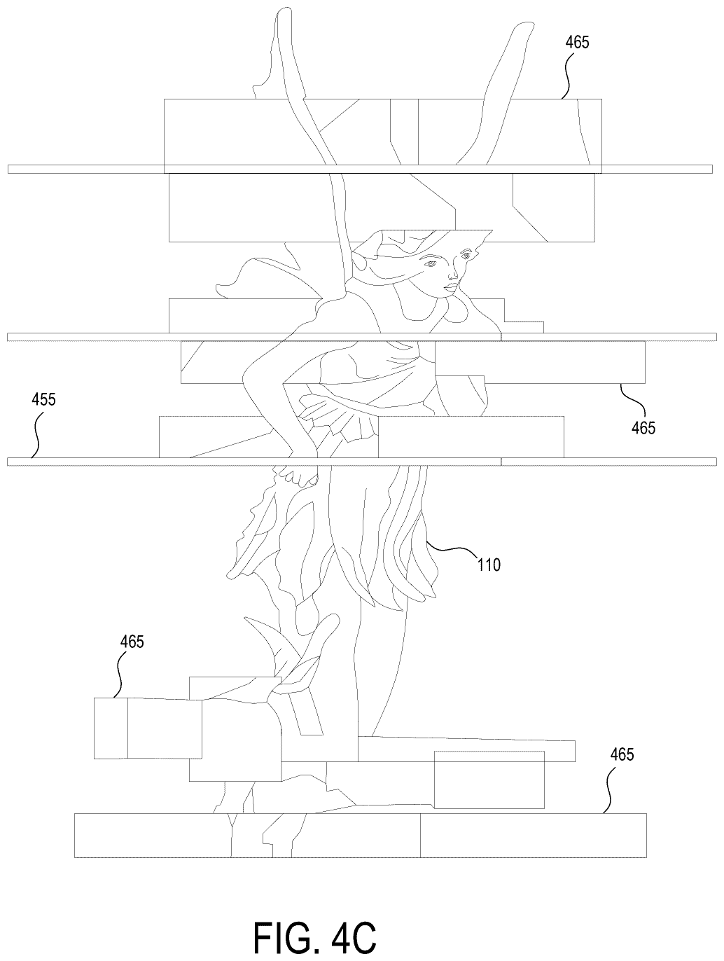

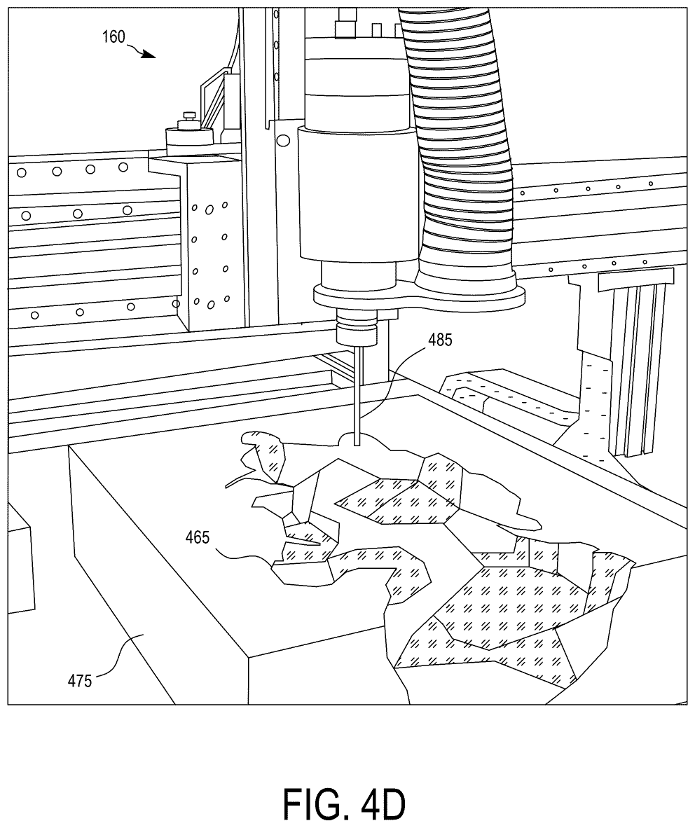

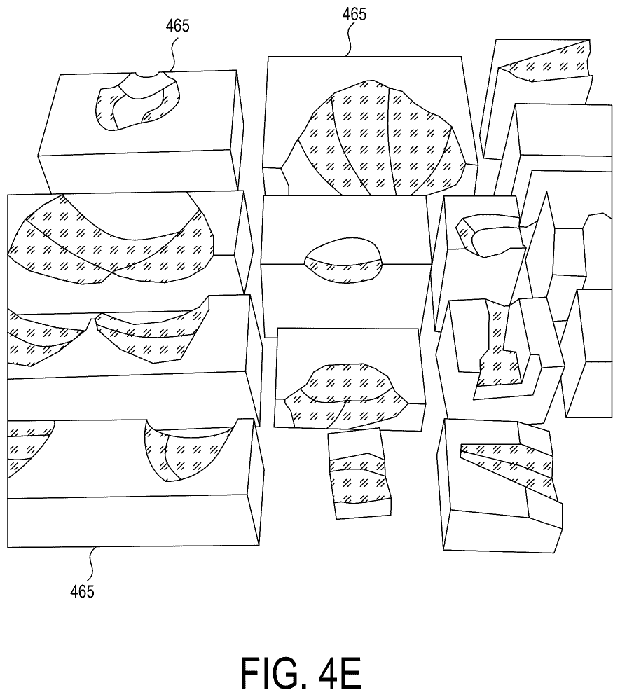

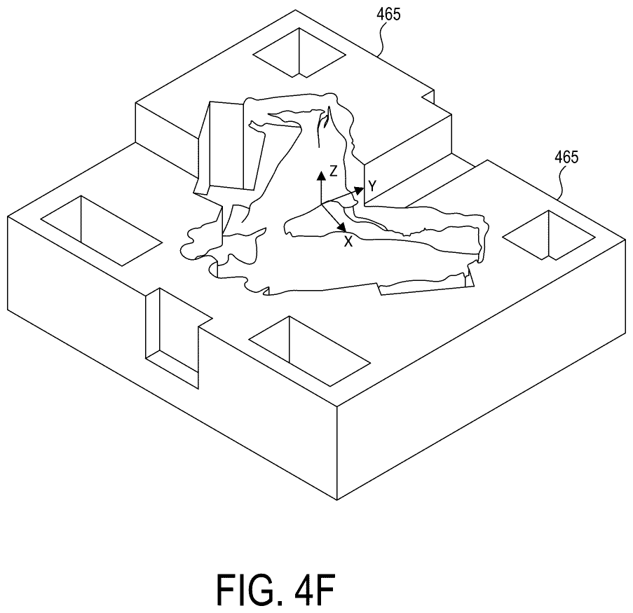

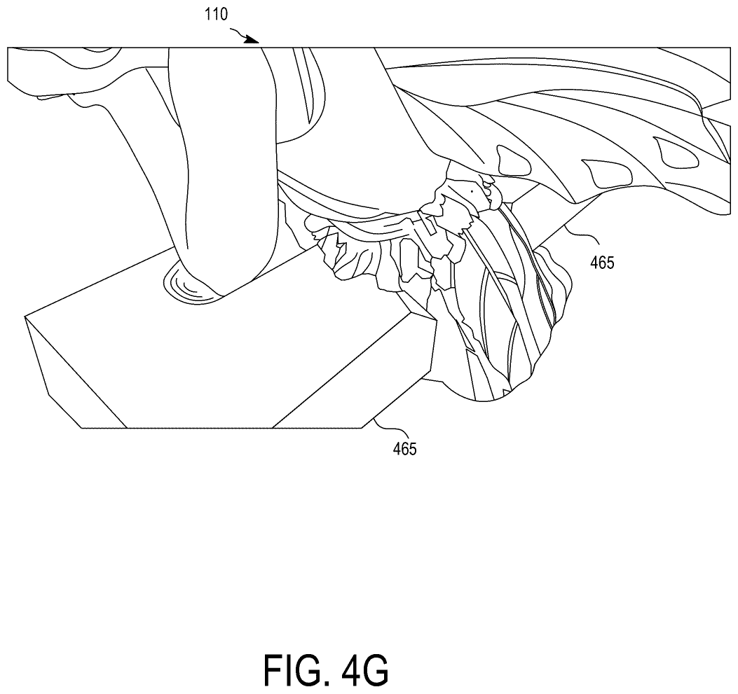

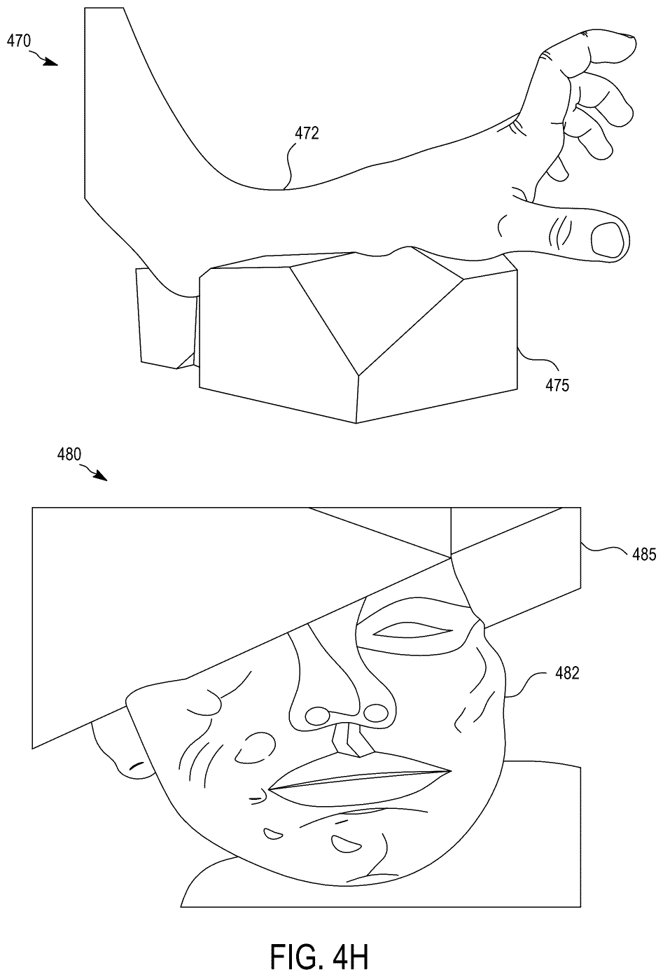

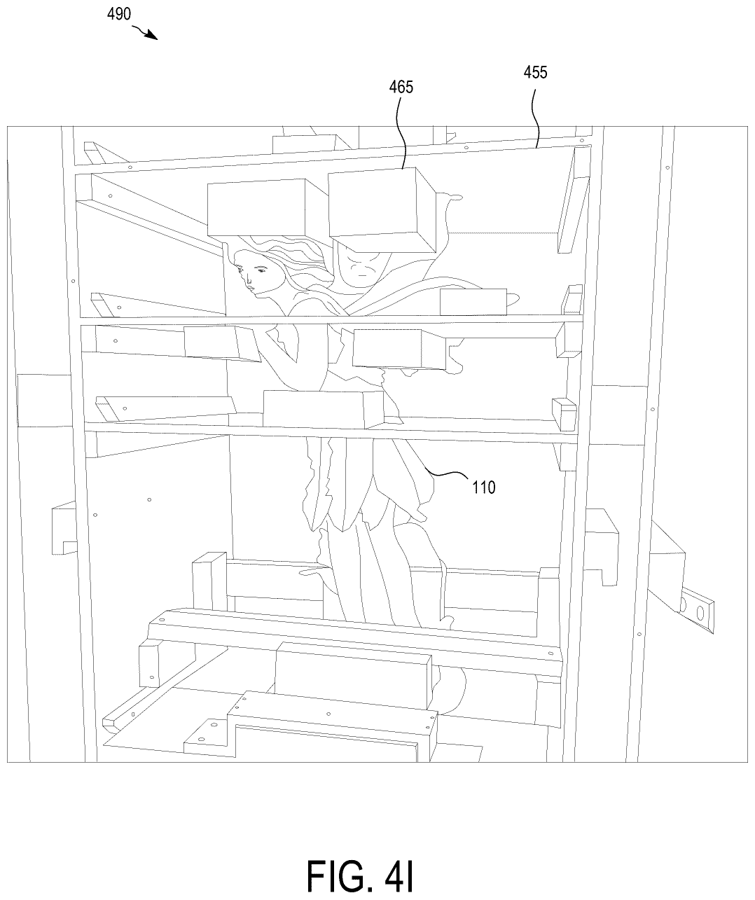

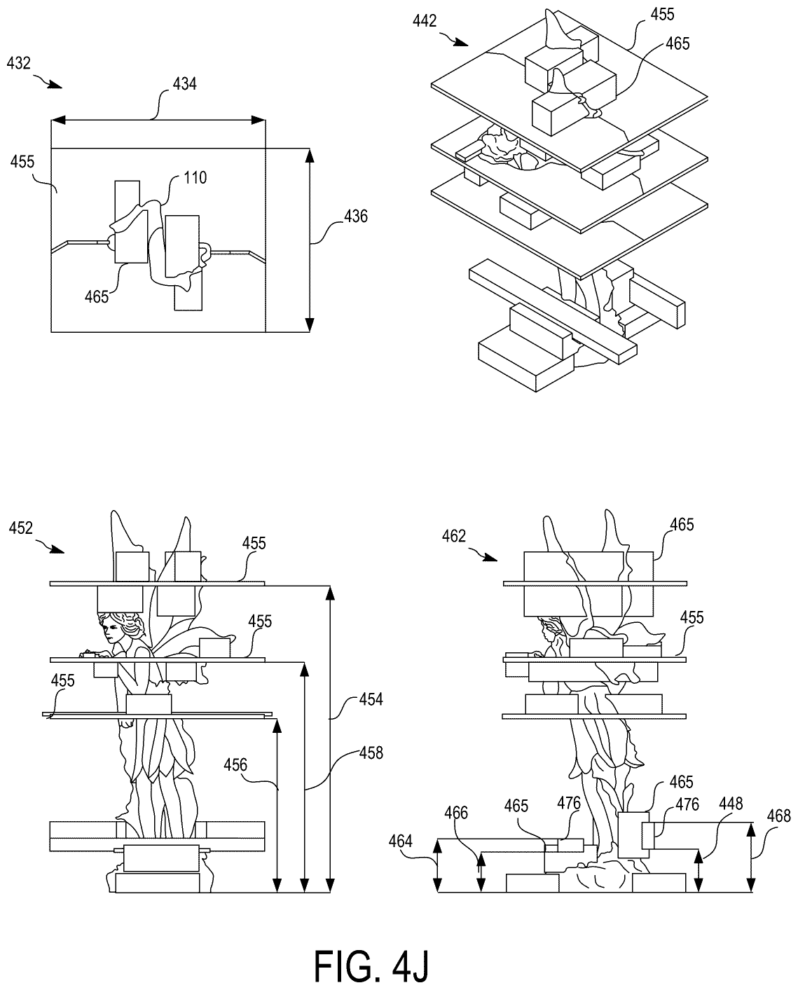

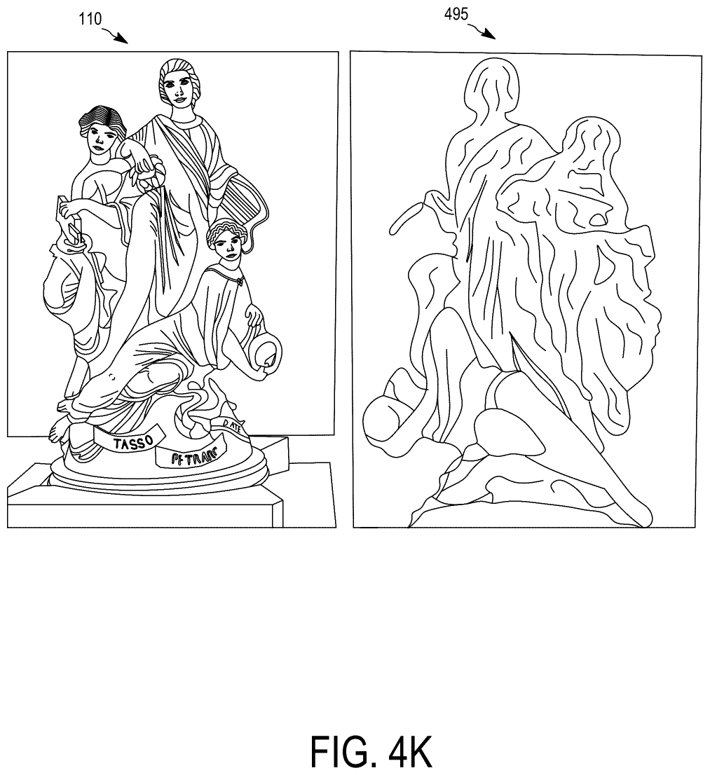

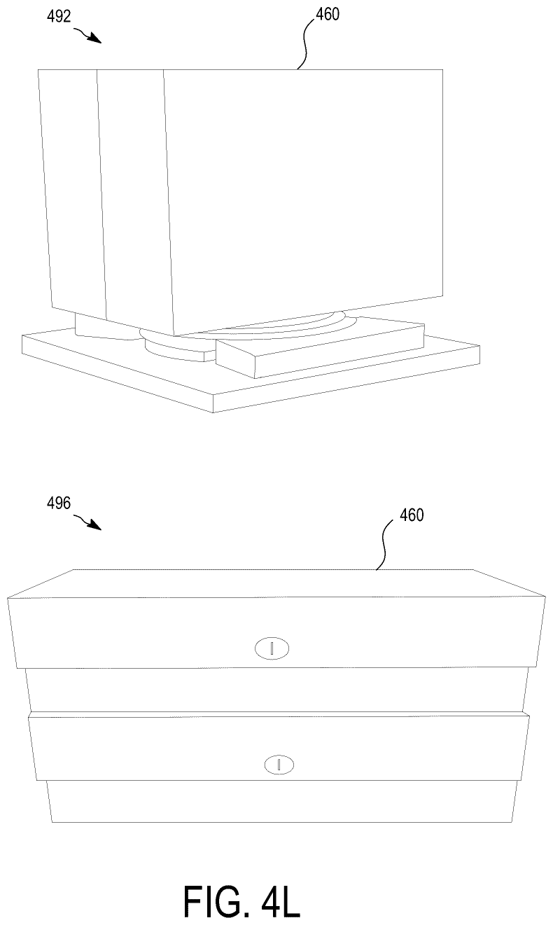

Referring to FIG. 4A, FIG. 4A is a schematic 400 illustrating scanning of an object in an embodiment of the disclosed subject matter. FIG. 4A comprises the scanner 130, the positional platform 120, the object 110, and a computer system 410. Each component is essential to provide the accuracy and completeness of the object scanning process, which serves as the foundation for subsequent stages in the object protection system.

The object 110 in the FIG. 4A represents the central element of the scanning process and is integral to the object protection system. The object 110 can be any three-dimensional item that requires customized protection for packaging and shipping. The object 110 in the FIG. 4A showcases its placement on the positional platform 120 and its interaction with the scanner 130 and the overall system.

The object 110 is depicted as being positioned securely on the positional platform 120, either manually or with the assistance of stabilizing features of the positional platform 120. This provides the object's stability during scanning, preventing unintended shifts or movements that could compromise the accuracy of the digital representation. The object 110 can vary widely in its characteristics ranging from fragile items like artwork and ceramics to robust components such as mechanical parts or consumer electronics. The object's material composition, surface texture, and geometric complexity are critical variables considered by the system.

The scanner 130 is depicted as the primary tool for capturing detailed data about the object's 110 physical characteristics and generating a digital representation 420 of the object 110. The scanner 130 may employ various technologies such as image sensors, optical scanning, RF signals, X-rays, or thermal imaging, depending on the material properties of the object being scanned. In one embodiment, the scanner 130 is integrated with the positional platform 120, forming a single compact unit where the scanning process is automated and seamlessly controlled. This integration enhances precision and efficiency, particularly for stationary workflows in industrial or packaging environments. In another embodiment, the scanner 130 is a portable device operated by a user, offering flexibility for scanning objects that are large, irregularly shaped, or situated in less controlled settings. FIG. 4A illustrates the embodiment where the user holds the scanner 130 with their hand 430 to capture the object 110. The scanner's 130 versatility ensures that it can capture intricate details, such as contours and surface irregularities, critical for creating protective packaging.

The positional platform 120, shown beneath the object 110, can be integrated with the scanner 130 or operate independently. In its integrated form, the positional platform 120 rotates and tilts dynamically, allowing the scanner 130 to capture the object 110 from multiple angles. This multi-axis movement ensures that even hidden or hard-to-reach surfaces are included in the digital model. For instance, the positional platform 120 can rotate an irregularly shaped sculpture to reveal intricate features, enabling precise documentation. In scenarios where the scanner 130 is handheld, the positional platform 130 may serve as a stabilizing surface, holding the object 110 securely to assist the user in capturing consistent data.

The computer system 410, depicted as connected to the scanner 130, acts as a control and data-processing hub. It receives raw scanned data from the scanner 130 and processes the scanned data into a highly detailed three-dimensional digital representation 420. The digital representation 420 includes attributes such as surface topology, dimensions, and structural balance, which are important for downstream analysis. The computer system 410 also serves as a repository for the scanned data, storing it in a feature database for easy access. Whether the scanner 130 is integrated with the positional platform 120 or used manually, the computer system 410 provides data integrity, validating the completeness of scans and allowing users to monitor the process in real-time. If necessary, the computer system 410 alerts operators to rescan specific areas for improved accuracy.

Referring to FIG. 4B, FIG. 4B is a schematic illustrating the digital representation 420 of the object 110 in an embodiment of the disclosed subject matter. The figure depicts the digital representation 420 of the scanned three-dimensional object 110 and highlights the process of identifying and marking contact points 450 (may also be referred to as packaging contact points). The digital representation 420 is a virtual model derived from the scanning process and is shown as a detailed and accurate visualization of the object's geometry. It includes intricate details such as surface contours, edges, and material attributes, enabling precise identification of areas crucial for packaging. The digital representation 420 is typically displayed in a three-dimensional view, allowing for rotation and zooming to analyze the object 110 comprehensively.

The packaging contact points 450 are key locations on the object's surface identified as optimal areas for securing brace inserts and providing structural support. In embodiments, the packaging contact points 450 are marked directly on the digital representation 420 in the figure, often highlighted with distinct symbols or colors for clarity. The packaging contact points 450 are chosen based on criteria such as the object's stability zones, areas suitable for packaging, and regions that can support the weight or pressure of brace inserts without causing damage. For example, a fragile vase might have its packaging contact points 450 marked on its base and upper rim, avoiding delicate areas with intricate detailing.

The figure further illustrates how these packaging contact points 450 are analyzed to determine the placement and design of the brace inserts. This process involves evaluating the object's physical attributes, such as weight distribution and center of gravity, which are embedded in the digital representation 420. By studying these packaging contact points 450 in the context of the object's geometry, the system ensures that the brace inserts are aligned to provide maximum stability and protection. This step is critical for objects with irregular shapes or uneven weight distribution, where the packaging contact points 450 must be strategically selected to prevent tipping or movement during transit.

In embodiments, FIG. 4B emphasizes the integration of digital tools to refine the contact point analysis. The system may use advanced algorithms to process the digital representation 420 to simulate the object's response to forces such as impacts or vibrations. This helps validate the suitability of the identified contact points 450 and guides the material selection for the brace inserts. The outcome is a comprehensive mapping of the contact points 450, seamlessly incorporated into the fabrication files for creating customized brace inserts.

Referring to FIG. 4C, FIG. 4C is a schematic illustrating assembly of the brace inserts to the object in an embodiment of the disclosed subject matter. For instance, the figure illustrates the assembly of the brace inserts 465 onto the object 110, providing a visual representation of how the protective components are integrated to safeguard the object 110 for packaging and transport. At the center of the figure is the three-dimensional object 110, surrounded by various brace inserts 465 designed to fit specific contours and structural requirements. Each brace insert 465 is shown aligned with its corresponding placement point on the object 110, emphasizing precision and customization in the protective design. The placement points may be identified using the packaging contact points 450.

The brace inserts 465 in the figure are depicted as modular components customized to the object's unique geometry. These brace inserts 465 are color-coded or labeled to indicate their type, such as cushioning inserts, stabilizing brackets, or structural frames. Each brace insert is designed to provide specific functionality, such as absorbing shock, distributing weight, or preventing movement during handling. The figure also highlights the orientation and alignment of these brace inserts 165, with protective components 455 or guides showing how they should be placed to securely brace the object 110.

In some embodiments, the assembly process may include a sequence of actions, starting with placing the first brace insert at a primary support point and progressing to additional inserts for comprehensive coverage. Finally, the figure emphasizes the final assembly where all the brace inserts 465 are securely attached to the object 110. The assembled configuration demonstrates how the brace inserts 465 interact to form a cohesive protective structure. The figure also highlights potential enhancements, such as locking mechanisms or adhesive strips, to keep the inserts in place.

Referring to FIG. 4D, FIG. 4D is a schematic illustrating generation of the brace inserts 465 using a manufacturing system 160 in an embodiment of the disclosed subject matter. The figure illustrates the generation of brace inserts 465 within the manufacturing system 160 by integrating materials and processes required to produce customized components. At the core of the illustration is the manufacturing system 160, represented by a machine such as a 3D printer or CNC (Computer Numerical Control) machine. The manufacturing system 160 is central to the production process, demonstrating the transformation of raw materials 475 into the custom brace inserts 465 that align precisely with the object's attributes and packaging requirements.

The manufacturing system 160 may comprise a driller 485 configured to create custom shapes of the brace inserts 465. The driller 485 in the manufacturing system 160 is a specialized tool integrated into the manufacturing system 160 and is designed to create custom shapes and features in the brace inserts 465. This tool is used to drill, cut, or shape the materials such as foam, MDO boards, or other substrates into precise configurations that align with the specific dimensions and attributes of the object 110 being packaged. The driller 485 ensures that each brace insert 465 is accurately crafted to fit the contours of the object 110, providing optimal protection by securely holding it in place during transport or storage.

Adjacent to the manufacturing system 160, the figure depicts the raw materials 475 used for packaging. These materials 475 are visually distinguished to reflect their specific properties, such as foam for cushioning, plastic for structural support, or corrugated cardboard for economical yet sturdy protection. The raw materials 475 may enter the manufacturing system 160, emphasizing the automated nature of the material handling process.

In embodiments, the production of the brace inserts 465 is depicted as a dynamic process within the manufacturing system 160. The figure illustrates the materials being shaped, molded, or cut into the desired configurations. For additive manufacturing methods, layers of the material may be shown being built up to create complex geometries. For subtractive methods, such as CNC machining, the material is removed from a larger block to produce the final insert shape.

Referring to FIG. 4E, FIG. 4E is a schematic illustrating the brace inserts 465 created by a manufacturing system 160 in an embodiment of the disclosed subject matter. The brace inserts 465 as depicted in the figure are of unique shape, size, and structural features customized to the specific requirements of the object 110 being packaged. Each brace insert 465 is designed to align with predefined packaging contact points and stability zones, providing optimal support and protection during handling, shipping, or storage. The created brace inserts 465 are highlighted to showcase intricate details like contours, grooves, or cavities, which are designed to align with the object's packaging contact points or stability zones.

FIG. 4F is another schematic illustrating the brace inserts 465 in three-dimensional form created by the manufacturing system 160 in an embodiment of the disclosed subject matter. For instance, the manufacturing system 160 creates the brace inserts 465 with precise dimensions defining length, width, and depth of the brace inserts 465. FIG. 4F highlights X, Y, and Z dimensions of the brace inserts showcasing their three-dimensional structure. The dimensions correspond to the detailed impressions customized to match the contours and specific attributes of the object 110 to be protected. These impressions are formed with accuracy to provide a snug fit and provide optimal structural support and protection.

Referring to FIG. 4G, FIG. 4G is a schematic example illustrating the assembly of brace inserts to a portion of the object in an embodiment of the disclosed subject matter. For instance, the figure demonstrates the assembly of the individual brace inserts 465 to the object 310. At the center of the illustration, a portion of the object 110 is displayed, surrounded by various brace inserts 465 specifically designed to align with the unique geometry of the object 110. The object 110 is shown on a stable platform, emphasizing the precision required for proper alignment and attachment of the brace inserts 465.

The assembly process is visually guided in the figure, illustrating an alignment of the brace inserts 465 at the portion of the object 110. The brace inserts 465 are shown attaching to designated points on the object 110, providing minimal movement during transport. The brace inserts 465 alignments with marked packaging contact points is crucial to achieving stability and safeguarding delicate parts of the object 110.

Similarly, FIG. 4H is another example illustrating the assembly of the brace inserts to the object in an embodiment of the disclosed subject matter. For instance, 470 demonstrates the assembly of an individual brace insert 475 to a portion 472 of the object 110. Further, 480 demonstrates the assembly of an individual brace insert 485 to another portion 482 of the object 110.

Referring to FIG. 4I, FIG. 4I is a schematic illustrating a final view 490 of the object fully protected with the brace inserts in an embodiment of the disclosed subject matter. At the core of the illustration, the object 110 is securely enveloped by a combination of customized brace inserts 465 that have been precisely designed and fabricated to align with the object's unique shape, contact points, and stability requirements. The object and its protective components 455 are presented in a way that highlights the snug fit of the brace inserts 465 for complete immobilization and structural integrity during transport or storage.

Referring to FIG. 4J, FIG. 4J illustrates multiple views of the object protected with the brace inserts and protective components in an embodiment of the disclosed subject matter. In the figure, 432 represents a top view of the protected object 110. The top view illustrates assembly of the braces 465 to the object 110 and assembling the protective components 455 while packaging. The protective components 455 depicted in FIG. 4J represent the topmost protective component assembled to the object 110. 434 indicates the length of the protective components 455, and 436 indicates its width. For example, for the object 110 with dimensions 20.6132*18.0916*50.3824, the length and width of the protective components 455 can be 28.25 inches and 24.26 inches.

FIG. 4J further illustrates a side view 442, a front view 452, and a rear view 462 of the object 110 protected with the brace inserts 465 and the protective components 455. The front view 452 depicts visualization of the object 110 protected with protective components 455 positioned strategically to align with the object's shape and the brace inserts 465. For instance, 454, 456, and 458 represent a distance or spacing of the protective components 455 from the base of the object. For example, 454 may indicate the distance of the topmost protective component from the base and it can be 40.50 inches based on the object's dimensions. In one example, 458 indicates the distance of the second protective component from the object's base and it can be 30.50 inches for the given object. In another example, 456 indicates the distance of the third protective component from the object's base and it can be 23.00 inches for the given object.

Further, FIG. 4J depicts the rear view 462 of the protected object 110. The rear view 462 illustrates the backside of the object protected with the brace inserts 465 and the protective components 455. The rear view 462 further depicts strategic positioning of the brace inserts 465 from the base of the object 110. The brace inserts 465 are custom-designed to match the specific shape, size, and contours of the object 110. In some embodiments, these brace inserts 465 may comprise extended supports 476 arranged to keep the object 110 stable, preventing tilting, sliding, or rotation. The extended supports 476 are arranged to maintain a consistent buffer zone or clearance between the object 110 and external packaging. For example, for protecting larger or heavier objects, the brace inserts 465 may include reinforced structures, such as denser foam cores, integrated wooden or metal supports, or cross-bracing elements as the extended supports 476. In some examples, the extended supports 476 may be an adjustable or modular components, such as sliders, locking mechanisms, or removable padding, for the objects with irregular shapes or varying dimensions. The rear view 462 of the object 110 depicts the positioning of the extended supports 476 onto the brace inserts 465 and distance of the extended supports 476 from the object's base. For instance, 464 and 468 indicate the distance from the object's base to the top of the extended supports 476. Further, 446 and 448 indicate the distance from the object's base to the base of the extended supports 476.

Referring to FIG. 4K, FIG. 4K is a schematic illustrating the object and its corresponding packaging mold in an embodiment of the disclosed subject matter. The figure presents a clear view of the object 110 on the left-hand side and its corresponding packaging mold 495 on the right-hand side, which has been designed to securely fit the object 110 for packaging purposes. On the left, the object 110 is shown in its original form, capturing its unique shape, size, and structural features. This representation focuses on the object's dimensions and overall characteristics, such as its irregular contours, delicate surfaces, and potential contact points. The purpose of this view is to emphasize the complexity and specificity of the object 110 that requires a customized packaging solution.

On the right-hand side of the figure, the packaging mold 495 of the object 110 is depicted, representing a customized cavity or structural form that matches the exact shape and dimensions of the object 110. This packaging mold 495 is created by the manufacturing system 160 to accommodate the object's unique features, so that it fits precisely into the packaging system. The packaging mold 495 serves as the basis for designing and manufacturing the brace inserts 465 or protective components 455, which are intended to hold the object 110 in place during transport or storage. This section of the figure highlights the importance of creating an accurate and functional packaging mold 495 that reflects the physical attributes of the object 110, providing secure containment.

The figure visually illustrates how the object 110 is aligned and positioned into the packaging mold 495 for optimal protection. This positioning step confirms that the object's most fragile or sensitive surfaces are shielded and that no unnecessary pressure is applied to areas of the object 110 that might be susceptible to damage.

Referring to FIG. 4L, FIG. 4L is a schematic illustration of a packaging box 460 in an embodiment of the disclosed subject matter. The figure illustrates the packaging box 460, a component of the object protection system, designed as part of the disclosed subject matter. The packaging box 460 safeguards the three-dimensional object during shipping and handling. In this embodiment, the packaging box 460 is customized to fit the specific requirements of the object 110, considering its unique dimensions, fragility, and other protective needs. As depicted in FIG. 4L, 492 indicates a first orientation of the packaging box 460 in an upright or standing position. This orientation highlights the vertical arrangements of walls of the packaging box 460. The packaging box 460 may incorporate stabilizing elements such as extended base or anti-skid materials that enhance balance and prevent tipping when the packaging box 460 is upright.

FIG. 4L further illustrates the packaging box 460 in second orientation as indicated as 496. In this orientation, the packaging box 460 may be depicted in a fully closed position from a front view. The outer structure of the box may be depicted with clear lines representing the rigid walls, corners, and edges, which are constructed to provide structural strength and protection against external forces such as impacts, vibrations, and compression during transit. In some embodiments, the packaging box 460 may be integrated with a self-locking mechanism, which eliminates the need for external adhesives or tapes. This mechanism provides a tight seal with additional protection against environmental factors such as moisture, dust, and temperature variations during transit. Further, the interior of the packaging box 460 may include dynamic cushioning materials, such as memory foam, that adapt to the shape of the object 110, ensuring a snug and secure fit.

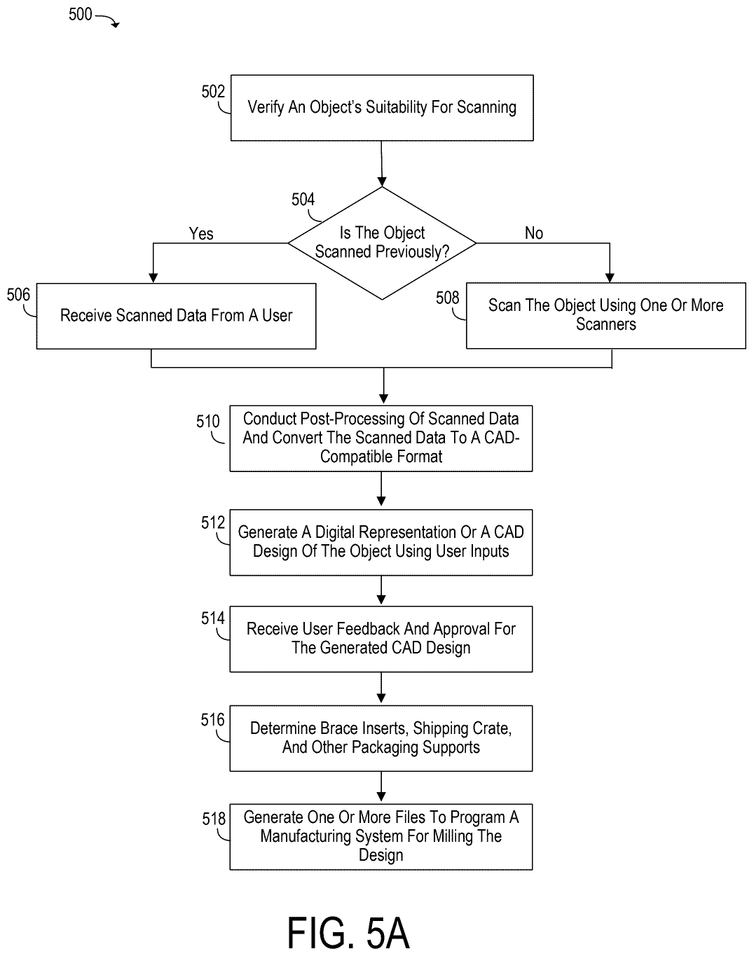

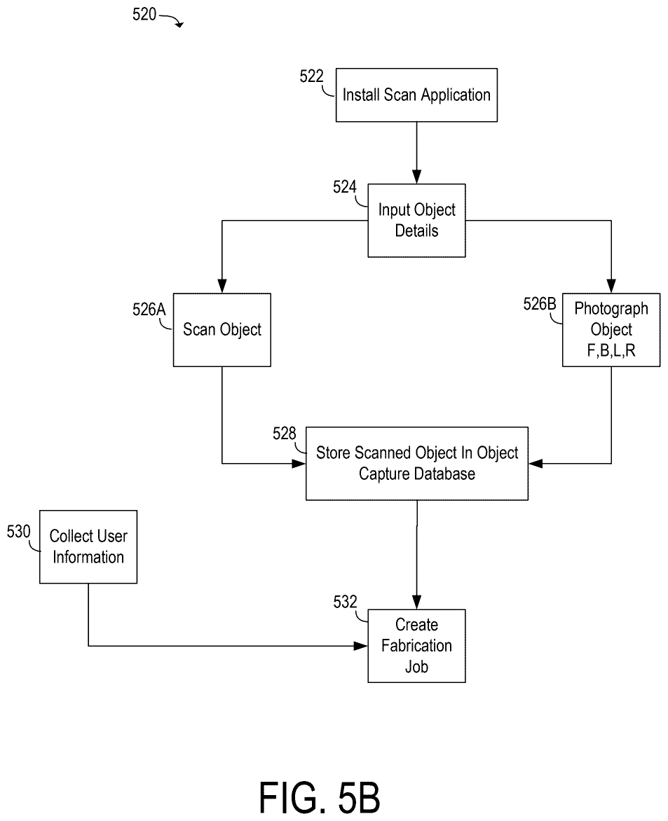

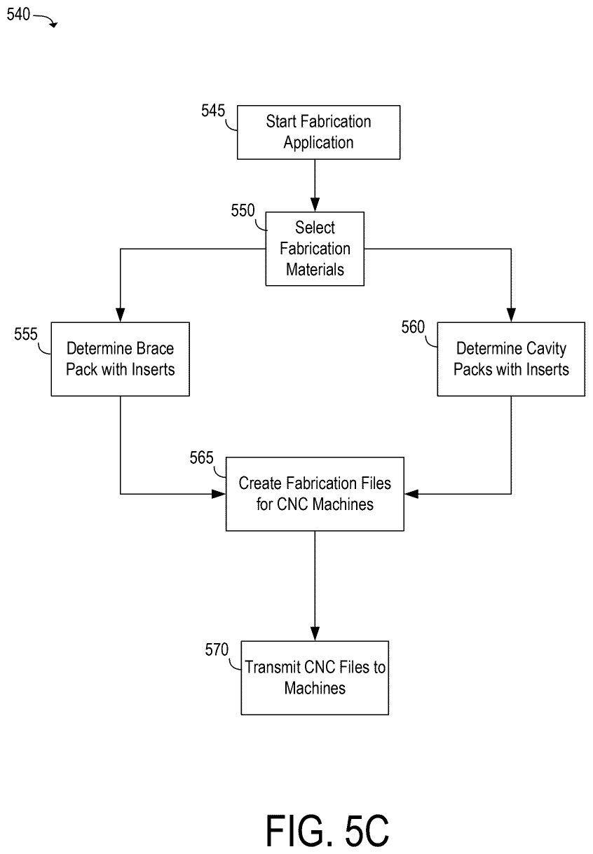

Referring to FIG. 5A, FIG. 5A depicts another illustration of a process 500 or method for protecting an object in an embodiment of the disclosed subject matter. The process 500 begins with verifying suitability of the object for scanning at step 502. At step 502, the process determines whether the object is suitable for scanning using an object database. The object database may comprise object category data, material data, and other data related to previously scanned objects. For instance, the process cross checks the object against the previously scanned objects to verify compatibility of the object with scanning equipment. In embodiments, the process verifies the object's suitability based on visual inspection or user-provided images.

At step 504, the process determines whether the object is scanned previously. For instance, the process may determine previous scanning of the object based on a user input. In some embodiments, the process may determine that the object is previously scanned using the object database that stores the data related to the previously scanned objects. If it is determined that the object is previously scanned, the process receives scanned data associated with the object from the user as illustrated at step 506. The scanned data may include one or more images captured by image sensors or optical scanners, and object's attributes captured by various sensors. In embodiments, the scanned data may include a three-dimensional scan of the object.

At step 508, the process determines that the object is not scanned previously, and an onsite scan is required. For instance, the process recommends onsite scan for fragile, large, and three-dimensional objects. The process scans the object using one or more scanners integrated with the object protection system. The one or more scanners comprise optical scanners, RF scanners, X-ray scanners, image sensors, thermal scanners, and other sensors capable of capturing various attributes of the object.

At step 510, the process conducts post-processing of the scanned data and converts the scanned data to a compatible format. The process analyzes the scanned data and modifies the three-dimensional scan to address imperfections and add custom modifications. The processed scanned data is converted into a format compatible with CAD (Computer-Aided Design).

At step 512, the process generates a digital representation or a CAD design of the object using user inputs. The CAD design or a digital representation is a 3D digital model of the object created using the CAD (Computer-Aided Design) software. This step converts the scanned object data into a CAD design which is a precise three-dimensional digital representation. The CAD design is the accurate representation of the object, including its dimensions, shape, and features, before physical production. In embodiments, the process receives the user inputs for generation of the CAD design. The process may set up a meeting with the user to generate the CAD design with the user inputs.

At step 514, the process receives the user feedback and approval for the generated CAD design. For instance, the process presents the generated CAD design to the user and receives the user feedback about the design changes and refinements. The process implements the modifications suggested by the user and obtains the user approval before proceeding to the fabrication stage. In embodiments, the process stores the user inputs and data related to the user meetings in the object database.

At step 516, the process determines one or more brace inserts, shipping crate, and other packaging supports required for packaging the object. For instance, the process analyzes the object attributes and pre-determined data stored in the object database. The predetermined data may include material properties (for example, impact resistance, vibration sensitivity), various object categories and structural attributes, packaging performance records and industry-specific standards. By analyzing the attributes and the predetermined data, the process determines the one or more brace inserts, shipping crate, the material required for packaging the object, and other packaging supports.

At step 518, the process generates one or more files to program a manufacturing system for milling the design. The one or more files may include fabrication files that comprise one or more instructions for the manufacturing system for producing customized brace inserts and other packaging supports. The process generates the one or more files by processing the object attributes and the material requirements.

Referring to FIG. 5B, FIG. 5B illustrates a process 520 for scanning and documenting objects. The process 520 begins with installation of a scan application on a user device or a computer system at step 522. The scan application is a central tool for capturing and storing all information related to the object. For instance, the scan application can manage diverse inputs like object dimensions, photographs, and scan data. This installation provides users or operators with access to the latest features for efficient data collection and processing.

At step 524, the process enables the user to input object details into the scan application. For instance, the user inputs critical details about the object into the scan application. These details are important for designing the packaging and providing safe handling of the object. For example, the object details may include physical specifications, material composition, historical information, condition notes, and packaging history associated with the object. The physical specifications may include dimensions (Width×Length×Height) and weight of the object. The material composition may include information about materials the object is made from (for example, wood, metal, glass, and the like). The historical information may include age of the object, particularly useful for antiques or fragile artifacts. The condition notes may include areas prone to damage such as fragile points or protrusions, zones that cannot tolerate contact with packaging materials. The packaging history may include details on previous packaging methods, if applicable. This step creates a comprehensive dataset so that all attributes of the object are documented for future reference.

At step 526A, the process performs a scan of the object using the scan application. In embodiments, the scan application may be integrated with the scanner to capture the three-dimensional scan of the object. The scan captures the object's exact shape, dimensions, and contours. This step provides a highly accurate digital representation of the object, which is used to design protective inserts or packaging components. The scanning process is particularly beneficial for objects with irregular or intricate shapes, allowing for precision in the fabrication phase.

At step 526B, the process captures photographs of the object using the scanner. For instance, the scanner captures photographs of the object from multiple angles: Front, Back, Left, and Right (F, B, L, R). These photographs act as visual documentation, supplementing the scanned data. The captured photographs provide a clear reference for identifying the object's surface features, colors, and potential vulnerabilities. In cases where the scan cannot fully capture fine details, the photographs confirm that nothing is overlooked.

At step 528, the process stores the scanned object in an object capture database. For instance, the scanned data and photographs are stored in the object capture database. The object capture database serves as a repository for organizing and preserving the collected data. The database provides accessibility for all stakeholders involved in the packaging process, including designers and engineers. For example, the database may use robust tools like SQL databases, Oracle, or FileMaker Pro to manage and secure the data efficiently.

At step 530, the process gathers user information relevant to the fabrication and packaging process. The user information may include customer details including name, contact information, and specific packaging needs. In embodiments, the process also collects information such as shipping requirements that include delivery location, handling preferences, and any additional notes from the client. In some embodiments, the process also collects CRM integration data collected using customer relationship management (CRM) tools.

At step 532, the process creates fabrication job using the collected information from the step 530. For instance, the fabrication job acts as a blueprint for designing and manufacturing the packaging solution. The fabrication job includes scanned models, photographs, product details, and customer information. This step confirms that all required information is consolidated and ready for the production process. In embodiments, the fabrication job may be managed using software platforms like Oracle, Access, or other SQL-based systems, which streamline the workflow and provide seamless communication between teams.

Referring to FIG. 5C, FIG. 5C illustrates a fabrication process 540 in an embodiment of the disclosed subject matter. The fabrication process creates customized brace and cavity packs used in packaging and transportation. The process provides precision and efficiency in producing protective packaging solutions, utilizing CNC machines and modern communication technologies.

At step 545, the process starts fabrication application. The fabrication process begins with the initiation of the fabrication application. For instance, the application is software that manages and organizes the entire fabrication process, from material selection to CNC file generation.

At step 550, the process selects fabrication materials. Once the application is started, users select the fabrication materials required for the packaging process. The material selection depends on the type of packaging being created (brace packs or cavity packs). The materials include foam, wood, corrugated boards, or other specialized materials suited to provide structural support or cushioning. The process may consider various factors during material selection. For example, the factors include object's weight and fragility, environmental considerations such as humidity resistance or shock absorption.

At step 555, the process determines brace pack with inserts. In this step, the process determines the design and configuration for brace packs using the fabrication application. The brace packs are structural supports designed to hold objects securely in place during transit. The inserts are designed based on the object's scanned data and product details including contours and dimensions. These brace packs prevent the object from shifting, absorbing external impacts, and protecting delicate or protruding sections.

At step 560, the process determines cavity packs with inserts. For instance, the fabrication application determines the design of cavity packs. The cavity packs are customized to fit the object snugly, providing even support and minimizing movement. These packs often include shaped inserts to cradle the object, particularly for irregularly shaped or fragile items. The inserts may be created using scanned object data, providing a precise fit.

At step 565, the process creates fabrication files for CNC machines. After defining the brace and cavity pack designs, the fabrication application generates fabrication files for CNC machines. The CNC machines use the fabrication files to cut and shape the packaging materials with high precision. For instance, the fabrication files are typically in standard formats like G-code or proprietary formats specific to the CNC machine being used. These files confirm that the packaging materials are cut to the exact dimensions and shapes required.

At step 570, the process transmits CNC files to machines. For instance, the final step of the fabrication process involves the transmission of fabrication files to CNC machines. The files are sent over a communication network, such as LAN (Local Area Network) or WAN (Wide Area Network). The CNC machines receive these files and execute the fabrication process, creating the final brace or cavity packs.

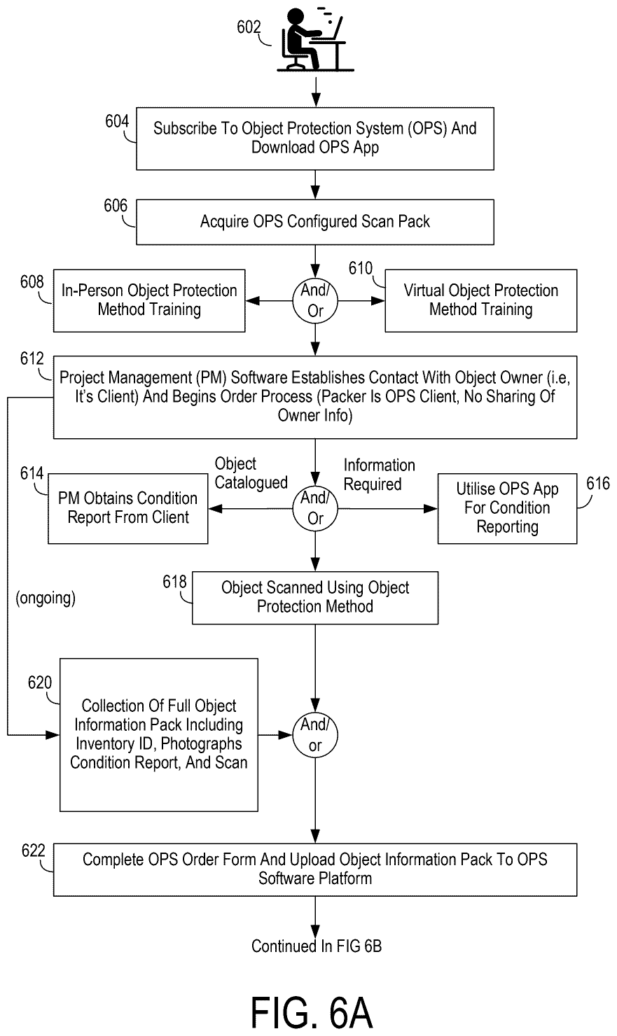

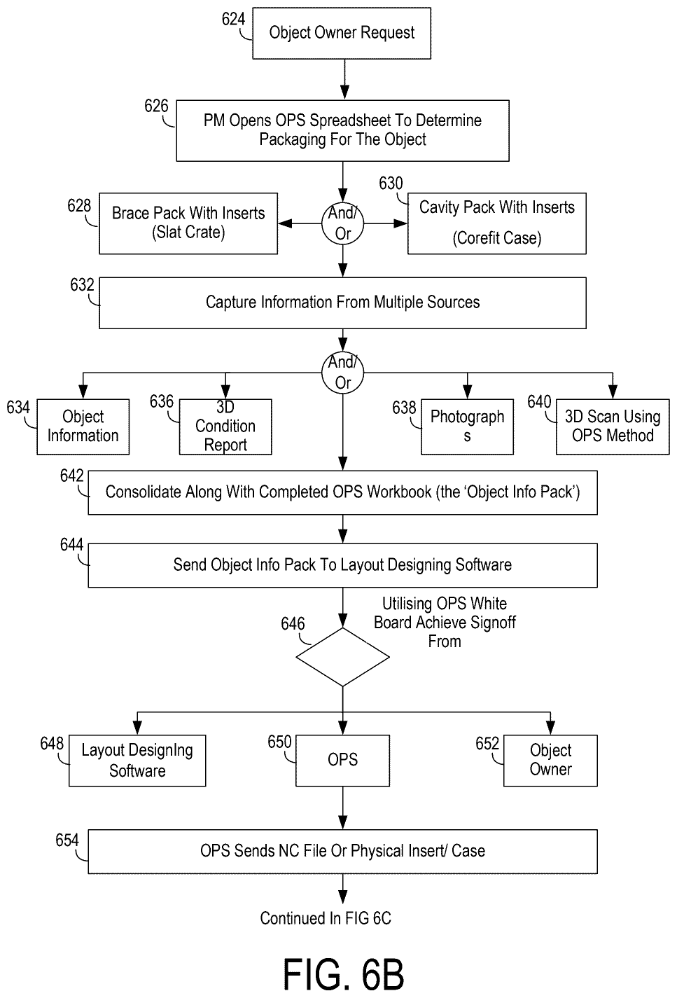

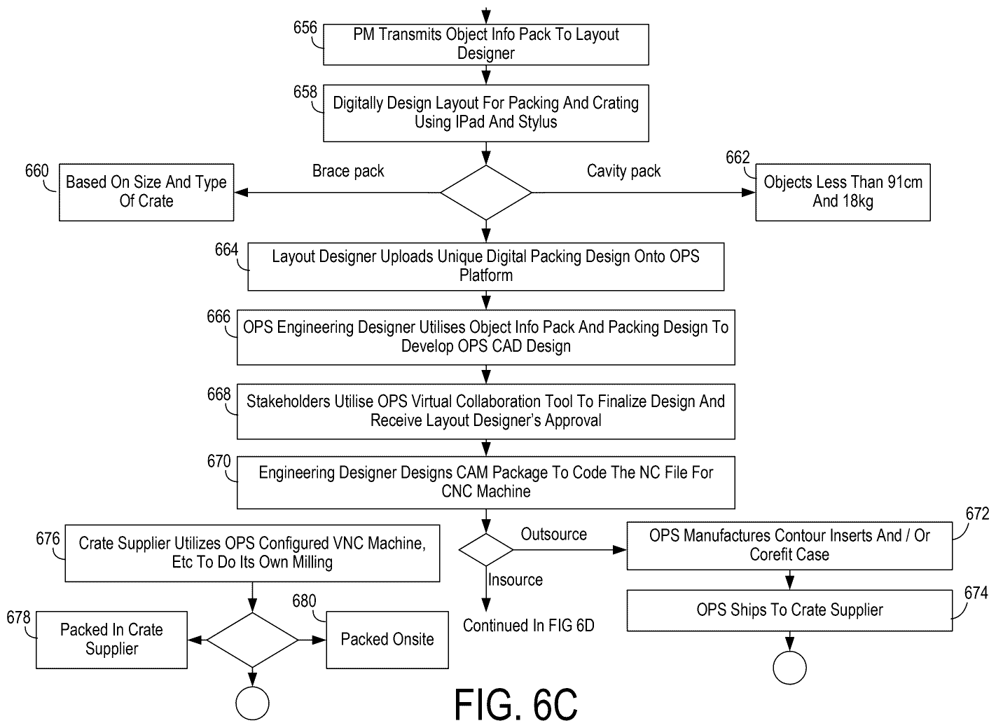

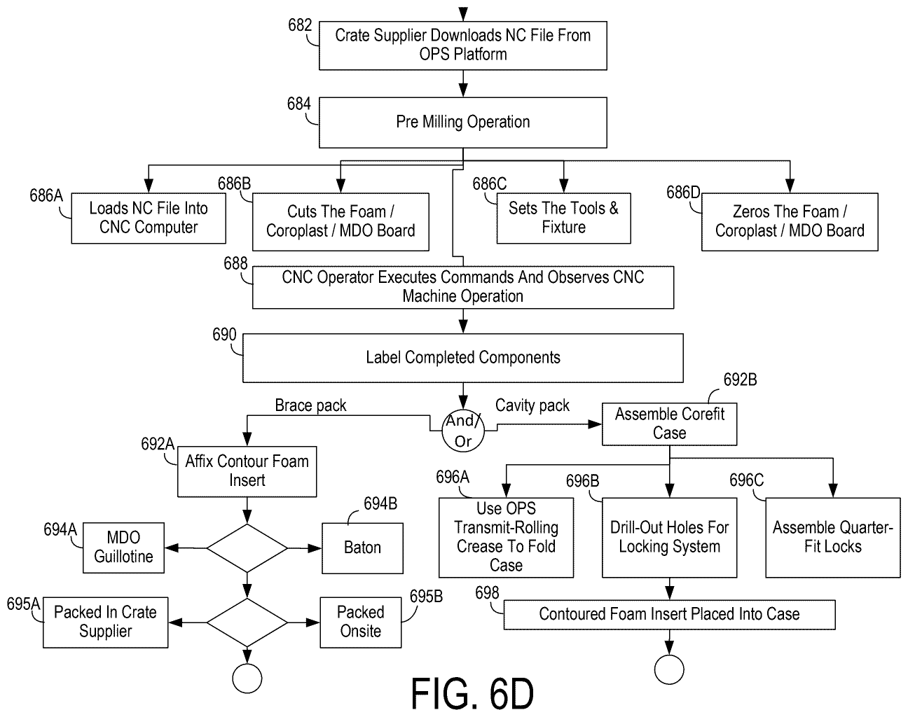

Referring to FIG. 6A to 6D, FIG. 6A to FIG. 6D depicts another illustration of a method for protecting an object in an embodiment of the disclosed subject matter. FIG. 6A illustrates an initial workflow for establishing an object protection method utilizing an Object Protection System (OPS). FIG. 6A depicts workflow starting from user subscription to the OPS system and culminating in the preparation of a comprehensive object information package for upload to the OPS system.

At step 604, a user 602 subscribes to the object protection system and downloads the OPS application (App). The process begins with the user subscribing to the Object Protection System and downloading the corresponding OPS application onto their device. This step confirms the user gains access to the OPS tools and functionalities necessary for object cataloging and protection.

In embodiments, the user 602 of the Object Protection System (OPS) can include a wide range of individuals and organizations. Individual users, such as object owners, may use the system to protect, catalog, or monitor valuable items for security, preservation, or insurance purposes. Professional packers and logistics providers utilize the OPS for scanning, cataloging, and condition reporting of objects during packaging or transport. Museums, art galleries, and collectors utilize the system to maintain inventory records and monitor the condition of artifacts or collections. Insurance companies may rely on detailed object information packs for policy issuance, claims processing, and risk assessment. Auction houses and appraisers use the system to document the condition and attributes of objects for sale or valuation, while restoration experts can record the condition of objects before and after conservation work. For instance, the OPS service providers support the platform's operation by offering training, maintaining infrastructure, and providing adherence to protocols, making the system adaptable across various industries and user needs.

At step 606, the process acquires OPS configured scan pack. For instance, once the subscription and app installation are complete, the user obtains an OPS-configured scan pack. This scan pack includes specialized tools or equipment designed to assist in object scanning and cataloging processes. These tools are optimized to comply with OPS standards and provide accurate and consistent results.

At step 608, the process provides training on object protection methods. For instance, users may choose to undergo in-person training, where they are educated on how to handle objects using the OPS protection methods. This training provides hands-on experience to ensure adherence to best practices.

At step 610, the process enables the users to opt for virtual training sessions, allowing them to learn the OPS methods remotely. This option offers flexibility and convenience, enabling all users to handle the subsequent steps in the workflow.

At step 612, the process establishes contact with object owners using a project management software. For instance, the project management (PM) software or a project manager plays a central role in coordinating with the object owner (client). The PM software establishes contact and initiates the order process while providing the confidentiality of the owner's information. At this stage, a packer of the OPS platform becomes the primary point of contact and is responsible for handling objects. The owner's information in this scenario remains secure.

At step 614, the PM software obtains condition report from the client if the object is catalogued. For instance, the PM software starts the process of cataloging the object. This involves identifying and recording key details about the object.

At step 616, the process utilizes the OPS App for documenting the object's condition if the condition information is required. The condition report captures essential attributes of the object, providing a baseline for future reference.

At step 618, the process includes object scanning using the object protection methods This step involves capturing precise details about the object's structure, attributes, and condition, so that the information meets OPS standards.

At step 620, the process includes collection of full object information pack. In embodiments, the process further includes compiling a comprehensive object information pack. This pack includes an inventory ID (a unique identifier for the object), the object's medium (for example, material type), one or more photographs taken from front (F), back (B), left (L), and right (R) angles, the condition report, and the detailed scan of the object.

At step 622, the process uploads the object information pack to the OPS platform. For instance, the process completes the OPS order form and uploads the object information pack to the OPS software platform. This enables the object's details to be securely stored and accessible for further actions, such as monitoring, tracking, or protection.

FIG. 6B is a continuation workflow for the object protection process or the method. In embodiments, FIG. 6B depicts an exemplary workflow of the project management software from assessing the object's requirements to designing and producing customized packaging components.

At step 624, the process receives a request from the object owner. For instance, the process begins when the three-dimensional (3D) object owner submits the request for protection or transportation of the object. This request serves as the starting point for confirming the object is appropriately assessed and packed for safety.

At step 626, the project manager (PM) or the project management software opens the object protection system spreadsheet. This spreadsheet contains predefined workflows and criteria to determine the suitable type of packaging for the object, based on its dimensions, fragility, and other characteristics.

At step 628 and 630, the project management software evaluates the packaging requirements and selects one of the two available methods for packaging components. For instance, at step 628, the process determines brace pack with inserts (referred to as brace inserts) for securing the object in a slat crate. This option involves securing the object in the slat crate with custom-fit inserts to brace the object, preventing movement during transport. This is ideal for objects with complex shapes or high fragility. At step 630, the process determines cavity packs with inserts as packaging components along with a core-fit case. For example, a core-fit case with cavity inserts is selected when the object can be supported within a structured container that provides cushioning around it.

At step 632, the process captures information from various sources. For instance, to confirm the object is packaged appropriately, various sources provide critical information such as object information 634, 3D condition report 636, photographs 638, and 3D scan using OPS methods 640. The object information 634 comprises basic details about the object, such as dimensions, weight, material composition, and usage. The 3D condition report 636 comprises a detailed report on the object's physical condition created to document any existing damage or vulnerabilities that need consideration during packaging. The photographs 638 comprises high-quality images of the object taken from multiple angles, including front, back, interior, and rear, to provide accurate reference for design and documentation. The 3D scan using OPS method 640 includes the 3D scan of the object performed using the OPS method. This scan provides precise digital measurements and a detailed model of the object, which helps in creating custom-fit packaging.

At step 642, the captured information is compiled into a single, comprehensive document called the “Object Info Pack.” This pack includes all necessary details about the object, as well as the completed OPS workbook, which outlines the steps taken to collect and prepare the data.

At step 644, the Object Info Pack is sent to layout designing software. This software is used to design the packaging or inserts, providing a perfect fit for the object based on the data provided in the pack.

At step 646, the process utilizes OPS whiteboard to achieve a Sign-off. For instance, the Sign-off refers to obtaining formal approval or authorization from key stakeholders to proceed to the next step of the process. It acts as a checkpoint to confirm that all relevant parties are satisfied with the decisions and designs made thus far. In embodiments, the Sign-off is required to confirm that all stakeholders agree on the proposed design. The Sign-off can be obtained from a layout designing software 648, OPS 650, or the object owner 652. If approved, the Object Info Pack is sent to the layout designing software 648 for designing the layout of the packaging inserts or case. If additional review or refinement is needed, the OPS 650 team may provide input before moving forward. In some cases, the object owner 652 must provide final confirmation before packaging proceeds.

At step 654, the object protection system sends a digital file and physical packaging material to the layout designer or the layout designing software. In embodiments, the OPS sends either a digital file used for automated manufacturing processes or the physical insert or case. The digital file may include a numerical control (NC) file used for automated manufacturing processes to produce the inserts or case. The physical insert or case may include a completed custom-fit protective case or insert ready for use. In some embodiments, the physical inserts may include packaging material required for generating brace inserts.

FIG. 6C is a continuation workflow for the object protection process or the method. In embodiments, FIG. 6C depicts an exemplary workflow of the layout designing and engineering designing processes in an embodiment of the disclosed subject matter.

At step 656, the process transmits the Object Info Pack to the layout designer. For instance, the project manager or the project managing software sends the finalized “Object Info Pack” to the layout designer. This document includes all critical details needed for designing the packaging and crate.

At step 658, the process digitally designs a layout for packing and crate. For instance, using tools such as an iPad and stylus, the layout designer creates a digital design or layout for the packaging and crate creation. This design considers the object's specific requirements and the selected packaging method.

Upon creating a digital design, the process determines a packaging type at steps 660 and 662. A decision is made based on the size and weight of the object. For example, a brace pack is chosen for larger or heavier objects that require slat crate packaging. A cavity pack is chosen for smaller objects, generally less than 91 cm and 18 kg, which fit into the core-fit cases.

At step 664, the layout designer uploads the unique digital packing design to the OPS platform. This step ensures all stakeholders and engineers have access to the design.

At step 666, an OPS engineering designer uses the Object Info Pack and the digital packing design to develop a precise CAD (Computer-Aided Design) file. This CAD design serves as the blueprint for manufacturing protective packaging.

At step 668, stakeholders use the OPS virtual collaboration tool to review and finalize the CAD design. This step provides alignment among all parties, and the layout designer's approval is obtained before moving forward.

At step 670, the engineering designer designs a CAM (Computer-Aided Manufacturing) package to code the NC file for CNC machine. For instance, the engineering designer translates the finalized CAD design into a CAM (Computer-Aided Manufacturing) package. This package generates the NC (Numerical Control) file, which provides instructions for the CNC machine to create the inserts or case.

In embodiments, the packaging components or the brace inserts can be manufactured in-house or can be outsourced to crate suppliers. At step 672, the OPS manufactures at least one of contour inserts and the core-fit cases and ships to crate supplier as depicted at step 674.

At step 676, the crate supplier utilizes the NC file to operate OPS-configured VNC machines or other milling tools. This step involves cutting and shaping materials to produce the custom inserts or cases. Upon manufacturing, the packaging process takes place at steps 678 and 680. The object is packed within the manufactured crate or case at the shop as depicted at step 678. Alternatively, packing may be completed onsite, near the object's location as shown at step 680.

FIG. 6D is a continuation workflow for the object protection process. For instance, FIG. 6D depicts an exemplary workflow of the CNC manufacturing processes in an embodiment of the disclosed subject matter.

At step 682, the crate supplier initiates downloading of the NC (Numerical Control) file from the OPS platform. This file contains the precise instructions for the CNC machine to create the required packaging components.

At step 684, the process initiates pre-milling operations. Before initiating the CNC process, various setup operations are conducted to prepare the packaging materials and machinery. The pre-milling operations include loading NC File into CNC computer as depicted at step 686A. For instance, the NC file is uploaded to the CNC computer, providing instructions for material cutting and shaping. The pre-milling operations further include material preparation. At step 686B, the foam, coroplast (corrugated plastic), or MDO (Medium Density Overlay) board is prepared and cut to the required size. The pre-milling operations also include setting the tools and fixtures as depicted at step 686C. The CNC machine is set up with the appropriate tools and fixtures to match the material and design requirements. The pre-milling operations include zeroing the material as depicted at step 686D. The machine is calibrated by aligning the material (foam, coroplast, or MDO board) with the CNC machine's starting point, providing accurate cuts.

At step 688, the CNC operator monitors the machine as it executes commands from the NC file. The machine mills, cuts, and shapes the materials into the desired components with precision.

At step 690, the produced components are labeled for identification after the completion of the CNC process. This ensures that each brace insert, or brace pack can be matched to its corresponding design and packaging type.

The process branches based on the type of packaging being produced. For brace packs, the process affixes foam inserts as depicted at step 692A. The contour foam inserts are securely attached to the interior of the brace pack. Based on the requirement, a MDO Guillotine 694A or Baton 694B may be used for precise cutting and preparing structural supports. The brace pack can be packed either at the crate supplier as depicted at step 695A or packed onsite as needed as shown at step 695B.

In case of cavity packs, the components for the cavity pack are assembled into the final core-fit case at step 692B. At step 696A, an OPS transmit and rolling crease may be used for folding and assembling the case structure. At step 696B, the process drills out holes for locking system. For instance, holes for locking systems are drilled to secure the case components. At step 696C, the process assembles Quarter-Fit locks. These locks are installed for additional security. At step 698, the contoured foam inserts are placed into the assembled case to protect the object.

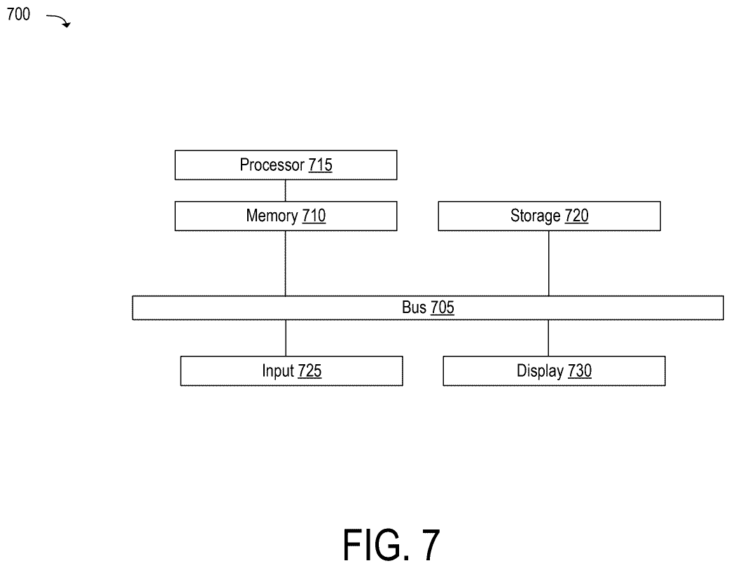

Referring to FIG. 7, FIG. 7 is a schematic 700 of a generic computer system that can implement various components and functionalities described in the disclosed subject matter. The computer system can represent the web server, client device, or other computing devices, such as desktop computers, laptops, tablets, smartphones, gaming consoles, and smart TVs. These devices can be used to perform the methods and processes described herein.

The computer system includes a bus 705 that facilitates communication between various components. The memory 710 allows for quick access and manipulation of data. It may include different types of memory, such as Random Access Memory (RAM) and Read-Only Memory (ROM). RAM is typically used for temporary data storage while the system is running. On the other hand, ROM may be used for permanent storage of firmware or system software that is not intended to be modified frequently.

The processor 715 handles the execution of instructions and performs calculations necessary for the operation of the system. The processor 715 may include various types of processing units such as Central Processing Units (CPUs), Graphics Processing Units (GPUs), Field-Programmable Gate Arrays (FPGAs), Complex Programmable Logic Devices (CPLDs), and Application-Specific Integrated Circuits (ASICs). Different types of processors may be used depending on the specific requirements of the application, with CPUs handling general-purpose processing, GPUs handling graphical and parallel processing tasks, FPGAs and CPLDs providing reconfigurable hardware logic, and ASICs offering customized processing solutions.

The storage 720 component is used to store data and software applications that the computer system uses and executes. Storage may include various types of storage devices such as solid-state drives (SSDs) and spinning disk drives (HDDs). SSDs have high speed and reliability, using flash memory to store data. HDDs, on the other hand, use magnetic storage to store and retrieve data, typically offering larger storage capacities at a lower cost compared to SSDs.

The input 725 and display 730 are peripheral components that may connect to the computer system. The input component may include devices such as keyboards, mice, touchscreens, and other peripherals that allow the user to interact with the computer system. The display component may include monitors, screens, or other visual output devices that present information to the user. The bus 705 facilitates communication between these components, allowing them to work together to perform the necessary operations.

Many variations may be made to the embodiments described herein. All variations, including combinations of embodiments, are intended to be included within the scope of this disclosure. The description of the embodiments herein can be practiced in many ways. Any terminology used herein should not be construed as restricting the features or aspects of the disclosed subject matter. The scope should instead be construed in accordance with the claims appended.

1. An object protection system, comprising:
a scanner configured to scan a three-dimensional object and generate a digital representation of the object;
a feature database configured to store one or more attributes of the object identified from the digital representation, the one or more attributes comprising packaging contact points;
an object analyzer configured to analyze the one or more attributes of the object to determine one or more brace inserts and material requirements for packaging;
a fabrication subsystem configured to generate fabrication files based on the analyzed attributes and communicate with a manufacturing system to produce the one or more brace inserts; and
a packing list generator configured to generate a customized packing list detailing assembly of the one or more brace inserts for packaging.

2. The system of claim 1, wherein the scanner comprises one or more devices selected from image sensors, optical scanners, RF scanners, X-ray scanners, and thermal scanners.

3. The system of claim 1, wherein the one or more attributes of the object further comprise at least one of dimensions, weight distribution, surface fragility, points of stability, and areas unsuitable for packaging contact.

4. The system of claim 1, wherein the one or more attributes are identified by processing the digital representation of the object, the processing configured to analyze surface topology, material density, and structural balance of the object based on the digital representation.

5. The system of claim 1, wherein the object analyzer comprises an object database configured to store pre-determined data on material properties, such as impact resistance and vibration sensitivity, to determine the selection of brace insert types and materials.

6. The system of claim 1, further comprises a positioning platform configured to hold and rotate the object in multiple orientations during the scanning process for scanning coverage of all surfaces of the object.

7. The system of claim 1, wherein the customized packing list comprises step-by-step assembly instructions for the one or more brace inserts, each instruction specifying a designated placement and orientation of the brace inserts relative to the identified packaging contact points.

8. The system of claim 1, wherein the fabrication subsystem is configured to generate fabrication files by processing the one or more attributes and the material requirements, the fabrication files comprising one or more instructions for the manufacturing system for producing customized brace inserts and other packaging supports.

9. The system of claim 1, wherein the one or more brace inserts and the material used for packaging provide structural protection to the object during shipping and are customized based on the object's unique attributes.

10. A method for protecting an object, the method comprising:
scanning the object using a scanner to generate a digital representation of the object;
identifying one or more attributes of the object from the digital representation, the one or more attributes including packaging contact points;
analyzing the one or more attributes to determine one or more brace inserts and material requirements for packaging;
generating one or more fabrication files based on the analyzed attributes;
communicating the fabrication files to a manufacturing system to produce the one or more brace inserts; and
generating a customized packing list detailing assembly of the one or more brace inserts for packaging the object.

11. The method of claim 10, wherein the scanner comprises one or more devices selected from image sensors, optical scanners, RF scanners, X-ray scanners, and thermal scanners.

12. The method of claim 10, further comprises storing the identified one or more attributes in a feature database.

13. The method of claim 10, wherein the one or more attributes of the object further comprise at least one of dimensions, weight distribution, surface fragility, points of stability, and areas unsuitable for packaging contact.

14. The method of claim 10, wherein identifying the one or more attributes comprises processing the digital representation to analyze surface topology, material density, and structural balance of the object.

15. The method of claim 10, wherein the object analyzer comprises an object database configured to store pre-determined data on material properties, such as impact resistance and vibration sensitivity, to determine the selection of brace insert types and materials.

16. The method of claim 10, wherein scanning the object comprises positioning the object on a positioning platform and rotating the object in multiple orientations to capture all surfaces of the object.

17. The method of claim 10, wherein generating the one or more fabrication files includes processing the one or more attributes and the material requirements, the fabrication files comprising one or more instructions for the manufacturing system for producing customized brace inserts and other packaging supports.

18. The method of claim 10, wherein the customized packing list comprises step-by-step assembly instructions for the one or more brace inserts, each instruction specifying a designated placement and orientation of the brace inserts relative to the identified packaging contact points.

19. The method of claim 10, wherein the one or more brace inserts and the material used for packaging provide structural protection to the object during shipping and are customized based on the object's unique attributes.

20. A computer readable storage medium having data stored therein representing software executable by a computer system, the software comprising instructions that, when executed, cause the computer readable storage medium to perform:
generating a digital representation of an object scanned by a scanner;
identifying one or more attributes of the object from the digital representation, the one or more attributes including packaging contact points;
analyzing the one or more attributes to determine one or more brace inserts and material requirements for packaging;
generating one or more fabrication files based on the analyzed attributes;
communicating the fabrication files to a manufacturing system to produce the one or more brace inserts; and
generating a customized packing list detailing assembly of the one or more brace inserts for packaging the object.
